(19) United States
(12) Patent Application Publication
(10) Pub. No.: US 2024/0260548 A1
(43) Pub. Date: Aug. 8, 2024

(54) Beehive Management System and Methods of Using Same

(71) Applicant: HiveTracks, Inc., Creston, NC (US)

(72) Inventors: James Thomas Wilkes, Creston, NC (US); Sarah Elizabeth Denton, North Hollywood, CA (US); Declan Graham Nishiyama, Boone, NC (US); Max Allan Siegfried Rünzel, Boone, NC (US)

(73) Assignee: HiveTracks, Inc., Creston, NC (US)

(21) Appl. No.: 18/434,217

(22) Filed: Feb. 6, 2024

Related U.S. Application Data
(60) Provisional application No. 63/443,794, filed on Feb. 7, 2023.

(51) Int. Cl. A01K 47/06; H04W 24/02; H04W 92/00

(52) U.S. Cl. CPC A01K 47/06; H04W 24/02; H04W 92/00

(57) ABSTRACT

A beehive management system. The beehive management system may include a server, wherein the server may include a server beehive tracking application, a controller, operating memory, and a communications interface. The beehive management system may further include a data store connected to the server; and wherein the controller may be configured to execute stored program instructions. The stored program instructions may include receiving data related to a beehive, through a network, from one or more sources; processing the beehive data; assessing a state of the beehive based on the processed beehive data; and generating one or more recommendations by a recommendations engine of the beehive management system to improve the state the of beehive.

### RELATED APPLICATIONS

This application is related and claims priority to U.S. Provisional Patent Application No. 63/443,794, filed on Feb. 7, 2023 the application of which is incorporate herein by reference in its entirety.

### TECHNICAL FIELD

The subject matter relates generally to beekeeping and more particularly to a beehive management system and methods of using same.

### BACKGROUND

Honey bees are a critical link in agricultural production. Unfortunately, managed honey bees have come under serious pressures from many different stresses, which has resulted in beekeepers losing many colonies. Computer- or software-based beekeeper management tools exist today. However, current management tools are generally passive record-keeping tools. The current management tools are limited, especially with respect to bee health assessment and providing recommendations to beekeepers for improving the health of their bee colonies.

### SUMMARY

In one embodiment, a beehive management system is provided. The beehive management system may include a server, wherein the server may include a server beehive tracking application, a controller, operating memory, and a communications interface. The beehive management system may further include a data store connected to the server; and wherein the controller may be configured to execute stored program instructions. The stored program instructions may include receiving data related to a beehive, through a network, from one or more sources; processing the beehive data; assessing a state of the beehive based on the processed beehive data; and generating one or more recommendations by a recommendations engine of the beehive management system to improve the state the of beehive. The beehive management system may further include a user access device, connectable to the server through the network, the user access device including a display, a user input configured to receive input from a user, and a communications interface. The beehive management system may further include a user interface device beehive tracking application. The related beehive data may include data related to any one or more of environment, terrain, region, atmospheric, weather, meteorological, hive inspection, observation, number of hives, hive/queen details, flora/bloom, insect occurrences, beekeeper experience level, honey production, past and/or current beehive management practices, results of actions based on one or more of the generated recommendations, and/or historical data of any one or more of the foregoing. The one or more sources may include any one or more of National Weather Service (NWS), National Oceanic and Atmospheric Administration (NOAA), National Aeronautics and Space Administration (NASA), the data store, direct input, data accessible through the network, other beekeepers, internal and/or external sensors, and/or any third-party entities that process or provide information from or based on any of the foregoing. The recommendations engine may include a machine learning component in generating the one or more recommendations. The controller may be configured to execute stored program instructions that may further include sending one or more push notifications to the user access device of the user. The one or more push notifications may include the generated one or more recommendations. The beehive data may be processed and assessed in real time. The recommendations engine may rely on real time beehive data input and/or stored beehive data input in generating the one or more recommendations.

In another embodiment, a method of using a beehive management system is provided. The method may include receiving data related to a beehive, through a network, from one or more sources; processing the beehive data; assessing a state of the beehive based on the processed beehive data; and generating one or more recommendations by a recommendations engine of the beehive management system to improve the state of beehive. Assessing the state of the beehive may include providing a health assessment of the beehive. The method may further include accessing the beehive management system via a user access device, through the network, the user access device may include a display, a user input configured to receive input from a user, and a communications interface. The user access device may further include a user interface device beehive tracking application. The related beehive data may include data related to any one or more of environment, terrain, region, atmospheric, weather, meteorological, hive inspection, observation, number of hives, hive/queen details, flora/bloom, insect occurrences, beekeeper experience level, honey production, past and/or current beehive management practices, results of actions based on one or more of the generated recommendations, and/or historical data of any one or more of the foregoing. The one or more sources may include any one or more of National Weather Service (NWS), National Oceanic and Atmospheric Administration (NOAA), National Aeronautics and Space Administration (NASA), the data store, direct input, data accessible through the network, other beekeepers, internal and/or external sensors, and/or any third-party entities that process or provide information from or based on any of the foregoing. The recommendations engine may include a machine learning component in generating the one or more recommendations. The method may further include sending one or more push notifications to the user access device of the user. The one or more push notifications may include the one or more generated recommendations. The beehive data may be processed and assessed in real time. The recommendations engine may rely on real time beehive data input and/or stored beehive data input in generating the one or more recommendations.

In yet another embodiment, a non-transitory computer readable storage medium storing a program of instructions executable by a machine to perform a method of using a beehive management system is provided. The method may include receiving data related to a beehive, through a network, from one or more sources; processing the beehive data; assessing a state of the beehive based on the processed beehive data; and generating one or more recommendations by a recommendations engine of the beehive management system to improve the state of beehive.

### BRIEF DESCRIPTION OF THE DRAWINGS

Having thus described the subject matter in general terms, reference will now be made to the accompanying drawings, which are not necessarily drawn to scale, and wherein:

FIG. 1 illustrates a block diagram of an example of a beehive management system, in accordance with an embodiment of the invention;

FIG. 2 through FIG. 52 illustrate screenshots of an example of a mobile app of the beehive management system shown in FIG. 1, in accordance with an embodiment of the invention; and

FIG. 53 through FIG. 62 illustrate screenshots of an example of a web portal of the beehive management system shown in FIG. 1, in accordance with an embodiment of the invention.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides a beehive management system and methods of using same.

In some embodiments, the beehive management system and methods provide a recommendation engine and a data store running on an application server that supports a hive tracking mobile app running on, for example, a beekeeper's mobile device.

In some embodiments, the beehive management system and methods provide a software-based, data-driven recommendation engine for beekeepers that uses, for example, a hive tracking mobile app to deliver specific advice based on, for example, but not limited to, observational data, blooming data, weather data, and management data.

In some embodiments, the beehive management system and methods provide a recommendation engine that uses, for example, a hive tracking mobile app to deliver recommended beekeeping management practices based on a plurality of data sources, such as, but not limited to, past practices, regional beekeeper activities, weather data, blooming data, and bee health symptoms observed.

In some embodiments, the beehive management system and methods provide a hive tracking mobile app that may include, but is not limited to, a “Welcome” portion, a “Account Create” portion, a “Apiary Creation” portion, a “Home/Apiary” portion, a “Hive Creation” portion, a “Hive/Apiary” portion, a “To-Dos” portion, a “Records” portion, an “Inspection” portion, a “Calendar” portion, a “Profile” portion, a “Community/Message” portion, a “Recommendations” portion, and a “Symptom Checker” portion.

In some embodiments, the beehive management system and methods provide a recommendation engine that may be used to improve bee health to increase pollination efficacy and honey harvests by, for example, reducing hive winter losses through improved beekeeper management practices.

In some embodiments, the beehive management system and methods provide a beehive management tool for guiding poorly-experienced beekeepers who otherwise may not be knowledgeable enough on their own to manage beehives effectively.

In some embodiments, the beehive management system and methods provide a beehive management tool for guiding poorly-experienced beekeepers to take certain actions and at the appropriate times to ensure effective management of their beehives and thereby improve the health of the bees and affect improved pollination and honey production.

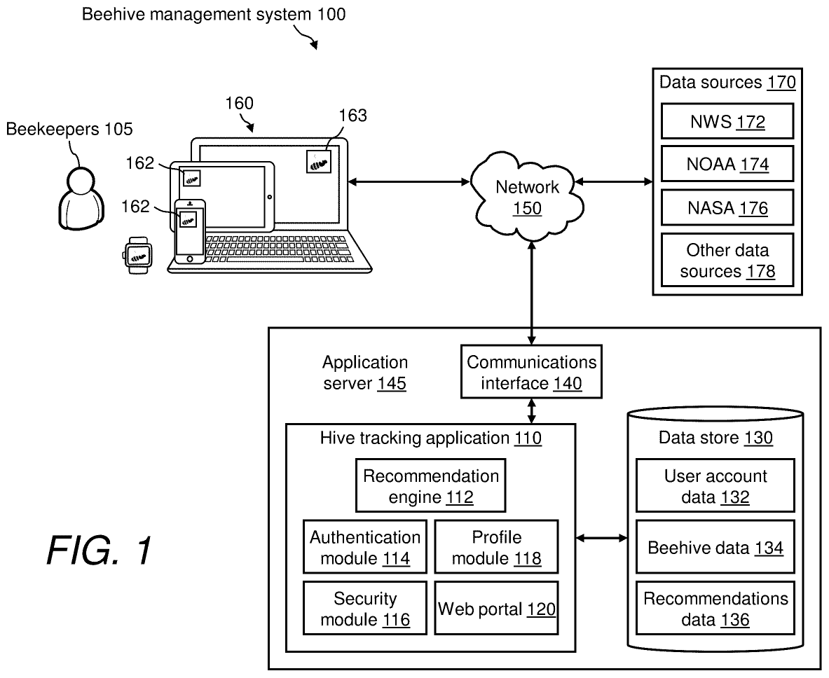

Referring now to FIG. 1 is a block diagram of an example of a beehive management system, in accordance with an embodiment of the invention. In this example, beehive management system 100 may be provided in a networked computing configuration that includes a beehive tracking application 110 and a data store 130 running on an application server 145.

At application server 145, beehive tracking application 110 may further include a recommendation engine 112 that supports a hive tracking mobile app 162, an authentication module 114, a security module 116, a profile module 118, and a web portal 120. Further, user account data 132, beehive data 134, and recommendations data 136 may be stored at data store 130. Additionally, application server 145 may be accessible via a network 150. Network 150 may be, for example, a local area network (LAN) and/or a wide area network (WAN) for connecting to the Internet or to an Intranet Further, network 150 may be a cellular internet connection. Application server 145 may connect to network 150 by any wired and/or wireless means. Application server 145 may include, for example, a communications interface 140.

A plurality of beekeepers 105 may be associated with beehive management system 100. However, in beehive management system 100, beekeepers 105 may be beekeepers or any other interested parties with respect to beekeeping. The beekeepers 105 may access beehive tracking application 110 at application server 145 via their respective user computers 160 and network 150. User computers 160 may be any computing device, such as, but not limited to, a desktop computer, a laptop computer, a handheld computing device, a mobile phone (or smart phone), a tablet device, a smartwatch, and the like. Any information about beekeepers 105 may be stored in user account data 132 at data store 130 of application server 145. For example, a user profile for each beekeeper 105 may be stored in user account data 132. Profile module 118 may be a software component of beehive tracking application 110 that may be used to manage user profile information of beekeepers 105 that may be stored in user account data 132. User account data 132 may include, for example, account information, user name, user group name, user/group credentials, user payment information, language preference, and/or the like.

In one example, beekeepers 105 may interact with the beehive tracking application 110 using web portal 120 at application server 145. In this example, web portal 120 may be a web-based user interface (UI) that is accessible via network 150. For example, beehive tracking application 110 at application server 145 may be a software application that may be implemented as a web application and run in a web browser, such as Google Chrome or Microsoft Edge.

A hive tracking desktop application 163 or hive tracking mobile app 162 may be installed and running on each of the user computers 160. Hive tracking desktop application 163 and/or hive tracking mobile app 162 may be implemented, for example, as a web application (i.e., React/Node), a desktop application, a mobile app, an application program interface (API), and the like. When configured as a mobile app, hive tracking mobile app 162 may be designed to operate on any device platform, including for example, Windows, Android, Apple, and the like. Accordingly, beekeepers 105 may interact with the beehive tracking application 110 using hive tracking mobile app 162 of their user computer 160 (e.g., smart phone or tablet device).

Beehive management system 100 may operate in a client/server computing architecture, which is well known. In this example, beehive tracking application 110 at the application server 145 may be the server component of beehive management system 100, while hive tracking mobile app 162 at each of the user computers 160 may be the client component of beehive management system 100. In other words, hive tracking mobile app 162 at each of the user computers 160 may be the counterpart to beehive tracking application 110 at application server 145.

Additionally, application server 145 may be any networked computing configuration as long as it is accessible via network 150 by other entities of beehive management system 100, such as beekeepers 105 and data sources 170. For example, beehive management system 100, and more particularly the beehive tracking application 110 on application server 145, may support a cloud computing environment. In a cloud computing environment, application server 145 may be the cloud server. Further, beehive tracking application 110 is not limited to running on one application server 145 only. Beehive management system 100 may include multiple application servers 145 (or cloud servers) in order to ensure high-availability of computing resources.

Referring still to FIG. 1, authentication module 114 of beehive tracking application 110 may be used to manage the authentication process of any entities of beehive management system 100, such as beekeepers 105 and any of the data sources 170. For example, when the beekeeper 105 signs into the beehive tracking application 110, a standard authentication process may be performed that allows the beekeeper 105 to access beehive tracking application 110. User-sign in may occur a number of ways. In one example, the beekeeper 105 may use a web browser access web portal 120 of beehive tracking application 110 and enter credentials (e.g., username and password).

In another example, the beekeeper 105 may use hive tracking mobile app 162 of their user computer 160 to enter his/her credentials. In yet another example, the user sign-in process may occur automatically when the beekeeper 105 starts hive tracking mobile app 162. As beekeepers 105 are authorized to access beehive management system 100, user information may be stored in user account data 132 in data store 130.

Security module 116 of beehive tracking application 110 may be used to perform any system security functions with respect to keeping secure the contents of data store 130 and/or any other information with respect to beehive management system 100. Security module 116 may use standard security techniques, such as encryption, secure hashtags (or hash tags), and the like. Data store 130 may be, for example, data repositories (like databases) and/or flat files that can store data. Further, beehive management system 100 is not limited to one data store 130 only. Beehive management system 100 may include multiple data stores 130. Further, data store 130 may be provided on a data server that is separate from application server 145.

Communications interface 140 at application server 145 may be any wired and/or wireless communication interface for connecting to a network (e.g., network 150) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Referring still to FIG. 1, beehive management system 100 may also include one or more data sources 170. Data sources 170 may include any sources of information, such as environmental information, that may be useful to beehive tracking application 110. Data sources 170 may include, for example, the National Weather Service (NWS) 172, the National Oceanic and Atmospheric Administration (NOAA) 174, the National Aeronautics and Space Administration (NASA) 176, and/or any other data sources 178 known now or in the future. Other data sources 178 may include, for example, any third-party entities that may process and provide information from NWS 172, NOAA 174, and/or NASA 176.

Other data sources 178 may include, for example, server-stored blooming information, plant, insect occurrences, satellite imagery, and/or beehive sensor data (Internet of things (IoT)) capturing data on local meteorological phenomena or beehive specific health data captured by an IoT hive-internal or -external sensor, including but not limited to, weight, sound, humidity, or temperature. Furthermore, apiary environment (i.e., urban, suburban, rural), terrain (mountain, forest, backyard, rooftop, grassland, coastal, forest/woods, other), number of hives, configuration of hives, experience level of beekeeper may be used as data sources. Finally, beekeeper ratings of recommendations sent serves as an additional input variable for recommendation delivery. Data sources 170 (e.g., NWS 172, NOAA 174, NASA 176, and/or other data sources 178) may be accessible to beehive tracking application 110 via network 150.

NWS 172 is an agency of the United States federal government that is tasked with providing weather forecasts, warnings of hazardous weather, and other weather-related products to organizations and the public for the purposes of protection, safety, and general information.

NOAA 174 is an American scientific and regulatory agency within the United States Department of Commerce that forecasts weather, monitors oceanic and atmospheric conditions, charts the seas, conducts deep sea exploration, and manages fishing and protection of marine mammals and endangered species in the U.S. exclusive economic zone.

NASA 176 is an independent agency of the U.S. federal government responsible for the civilian space program, as well as aeronautics and space research. NASA 176 may be the source of satellite data, such as, but not limited to, satellite imagery and its related data.

Generally, and referring still to FIG. 1, beehive tracking application 110 may be a software application that provides a means of processing information in real time and then pushing information to beekeepers 105 with respect to managing their beehives. Hive tracking mobile app 162 provides the means for beekeepers 105 to interact with beehive tracking application 110. For example, using hive tracking mobile app 162, push notifications may be automatically generated to beekeepers 105 and confirmation notifications may be returned from beekeepers 105 to beehive tracking application 110.

The two main components of beehive tracking application 110 may be recommendation engine 112 and hive tracking mobile app 162. Recommendation engine 112 may be a software component of beehive tracking application 110 that may be used as the analytics engine for generating actionable recommendations that are available to beekeepers. Further, recommendation engine 112 may include a machine learning component/model to improve the accuracy of recommendations made to beekeepers 105. For example, using machine learning, recommendation engine 112 may improve over time with respect to making better recommendations with respect to, for example, the frequency and/or types of actions a beekeeper may perform. Beekeepers 105 may record their beekeeping practices based on recommendations generated by recommendation engine 112 and the results thereof, which can be used by the recommendation engine 112 through machine learning to improve the generated recommendations over time.

Further, in one example, a beekeepers 105 may gain access to advice generated by recommendation engine 112 via the hive tracking mobile app 162. Hive tracking mobile app 162 is an app that helps beekeepers 105 manage, plan, and record their beekeeping practices.

More specifically, recommendation engine 112 may be a software-based, data-driven recommendation engine for beekeepers 105 that may provide specific advice based on, for example, but not limited to, observational data, blooming data, weather data, and management data. Further, example goals of recommendation engine 112 may be to improve bee health, to increase pollination efficacy, and/or honey harvests by, for example, reducing hive winter losses through improved beekeeper management practices. Further, the recommendation engine 112 may achieve its objectives by recommending beekeeping management practices based on, for example, but not limited to, past practices, regional beekeeper activities, weather data, blooming data, and/or bee health symptoms observed.

Recommendation engine 112 and hive tracking mobile app 162 may rely on (1) real-time input received from beekeepers 105 via, for example, hive tracking mobile app 162 and/or (2) certain information stored in beehive data 134 and/or recommendations data 136. Beehive data 134 may be any information about beehives of any beekeepers 105. For example, beehive data 134 may include records of past practices, regional beekeeper activities, weather data, blooming data, bee health symptoms observed, and/or the like. Recommendations data 136 may be any information that may be used to aid or otherwise inform recommendation engine 112. For example, a recommendation spreadsheet may be stored in recommendations data 136, and may be compiled including any information about any recommendations possible. Then, the recommendation spreadsheet may be transpiled into Node server code that runs each time recommendations are triggered, which can be time- or action-based. Both beehive data 134 and recommendations data 136 may contain regional information. Further, both beehive data 134 and recommendations data 136 may contain national, global, or non-regional information. Further, recommendation engine 112 may be used to process historical data. Accordingly, beehive tracking application 110 may provide and store all previous information associated with each beekeeper 105 in beehive data 134 at data store 140. Further, the size of the geographical area that defines a region of beekeepers 105 may be variable and may be set as desired within beehive tracking application 110 and/or hive tracking mobile app 162.

In some embodiments of beehive management system 100, the data generated during a beekeeper 105's interactions with recommendation engine 112 may be used to authenticate honey origin, the local impact of pollination ecosystem services, the state and continued monitoring of local biodiversity, and/or the readiness to access financial services, including micro-loans and/or insurance products. This data may be stored on, for example, a web3/blockchain based data base to increase reliability of the data

In some embodiments of beehive management system 100, the data types required to generate recommendations can be weighted differently to give one or more of the input factors more relevance than one or more of the others. Further, the recommendations may be generated with more sources of data, such as satellite images or IoT devices that collect data on, for example, bee health or activity and/or factors enhancing/limiting bee health and activity (see IoT-related information above). Also, the recommendations may be generated from less data sources. For example, excluding weather and/or blooming data.

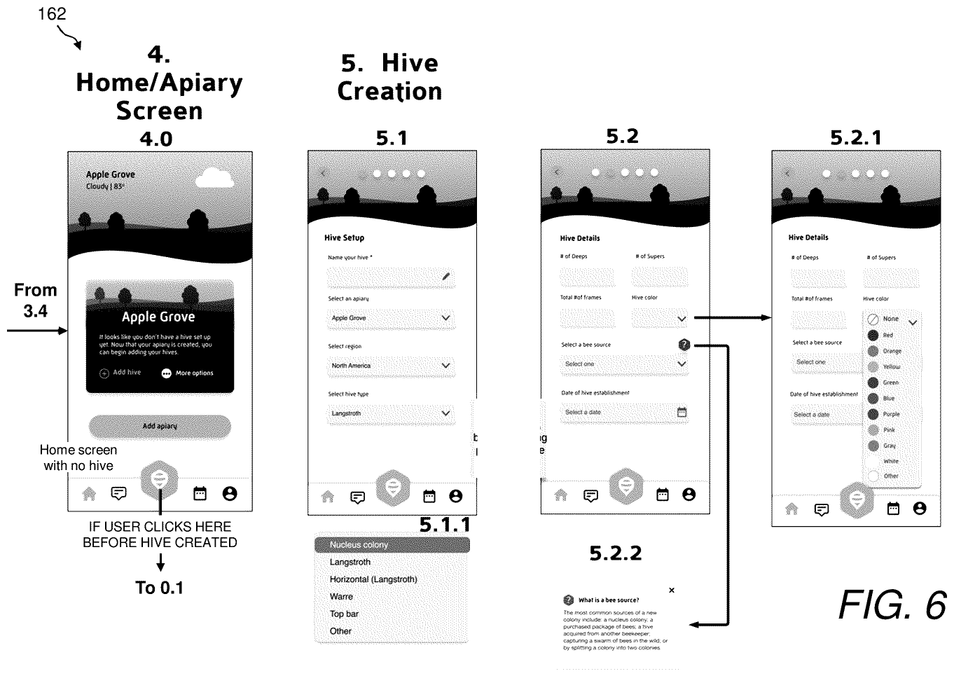

Generally, the operation of beehive tracking application 110 of beehive management system 100 may be described as follows. Firstly, beekeepers 105 access beehive tracking application 110 via their hive tracking mobile app 162. Hive tracking mobile app 162 may include a home screen that shows forward-looking to-dos and all records the beekeepers has saved. An example of a home screen of hive tracking mobile app 162 is shown in FIG. 6 and screen 4.0.

A key activity of a beekeeper 105 may be a hive inspection that is carried out about every two weeks during the beekeeping season, and less frequently during the off season. In the Northern Hemisphere the beekeeping season is generally from March to September of each year. During the inspection process, beekeepers 105 may answer a number of questions, for example:
(1) question(s) about the status and/or size of the hive population;
(2) question(s) about the presence of food stores;
(3) question(s) about the presence of the queen and/or brood stages; and/or
(4) question(s) about diseases and stressors, including potential symptoms.

Based on the data entered when answering these questions, beehive management system 100 may be used to process the information and provide a good assessment of the health of the hive. Beekeepers 105 then receive recommendations to act upon the findings in any of the four areas. For example, if low food stores are present, then a recommendation is made to feed the bees. If a stressor is present, then a recommendation is made to treat the bees. Then, perhaps a recommendation to plan the next inspection. All driven by recommendation engine 112 and hive tracking mobile app 162.

Generally, using recommendation engine 112, recommendations may be triggered by:
(1) direct input of a beekeeper into the hive tracking mobile app 162;
(2) input of regional beekeeper activities into the hive tracking mobile app 162; and
(3) information from any one or more of the plurality of data sources, such as, but not limited to, past practices, regional beekeeper activities, weather data, blooming data, bee health symptoms observed, and the like.

In addition, the hive tracking mobile app 162 shows aggregated tasks and records that have been carried out and completed by other beekeepers 105 that are using beehive management system 100. This information may be used to prompt recommendations for beekeepers 105 to plan the same actions for their own hive where necessary and/or improve the availability of foraging resources in the future. Examples may include the first inspection of the year, other beekeepers' harvesting schedules, or preparation for the winter.

Driven by recommendation engine 112, beekeepers 105 may also receive recommendations based on particularly good or bad weather. In one example, recommendations may be to feed when bees don't have good enough weather to forage for themselves. In another example, recommendations may be to add additional space (i.e., a so-called super as an additional box on top of the hive) to avoid the honey bee colony to outgrow its space and to swarm. Again, this process is facilitated via hive tracking mobile app 162.

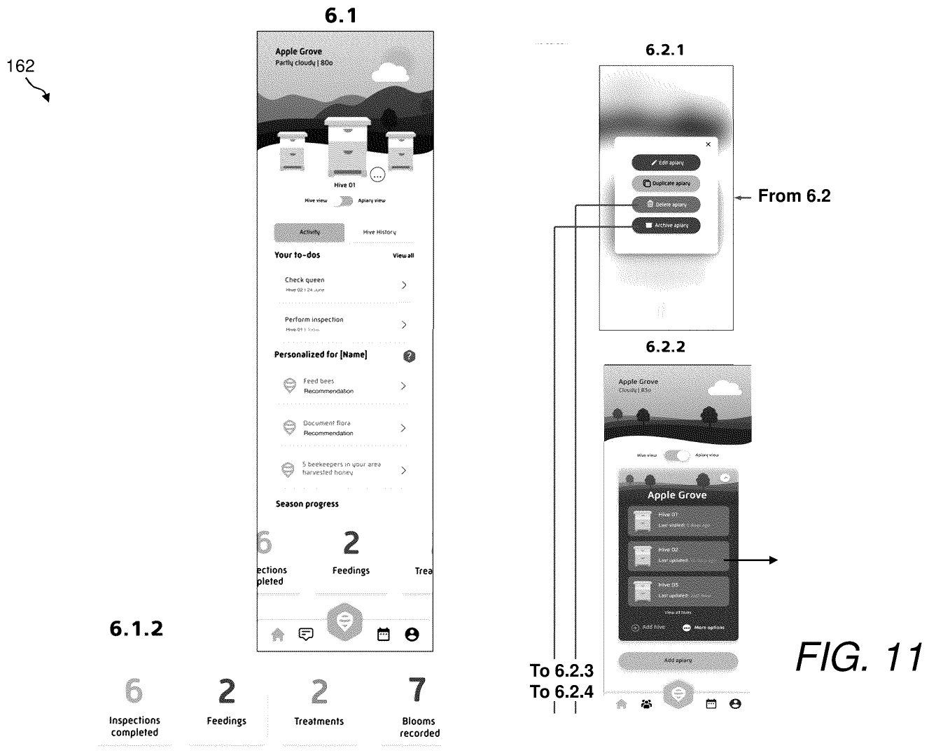

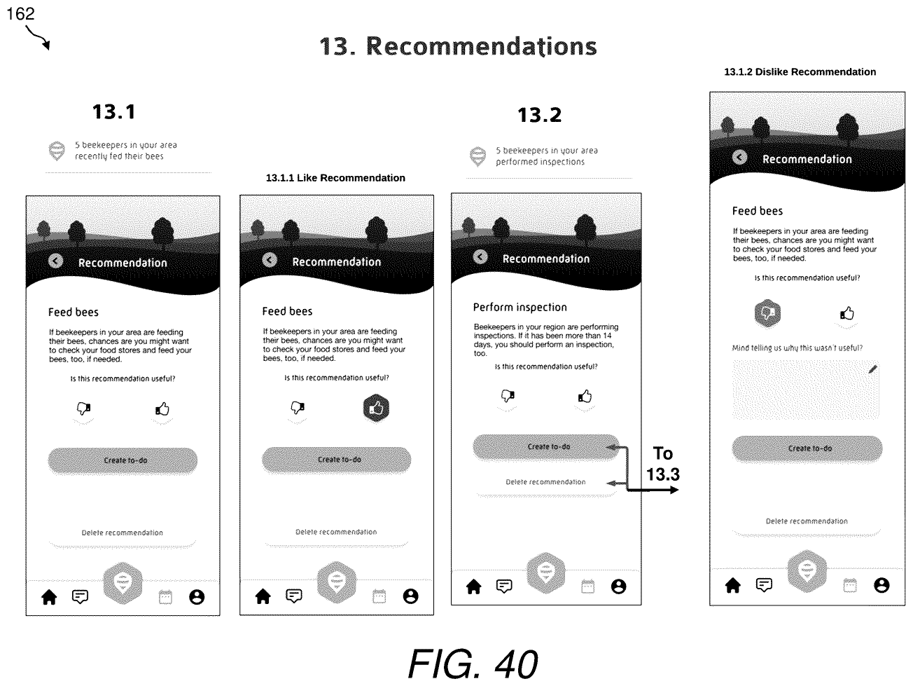

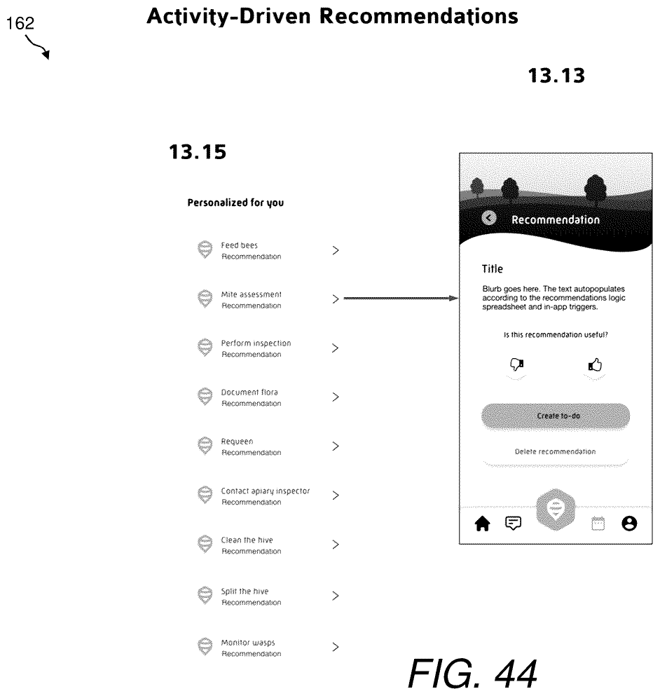

Then, beekeepers 105 receive recommendations via hive tracking mobile app 162 that may be based on blooming information in their area. In one non-limiting example, beekeepers may be asked to confirm the availability of certain plants and native pollinators to improve the recommendation engine and help in monitoring biodiversity around their hives. This information may indicate when nectar sources are available and foraging activities are the highest, which result in increased honey production. All recommendations may show up on the home screen of hive tracking mobile app 162 (e.g., see FIG. 11, screen 6.1) or the recommendation screen (e.g., “Recommendations” screens shown in FIG. 40 through FIG. 45), respectively, depending upon whether, for example, they are app-, community-, weather-, or blooming-related recommendations.

Using hive tracking mobile app 162, all recommendations may be accepted by the beekeepers 105 and turned into a to-do that can be scheduled for a specific day and hive, or dismissed and deleted.

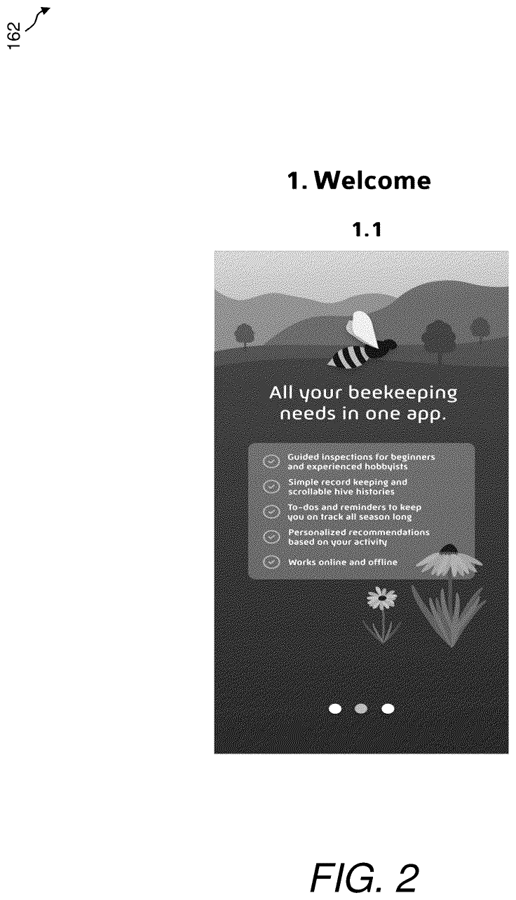

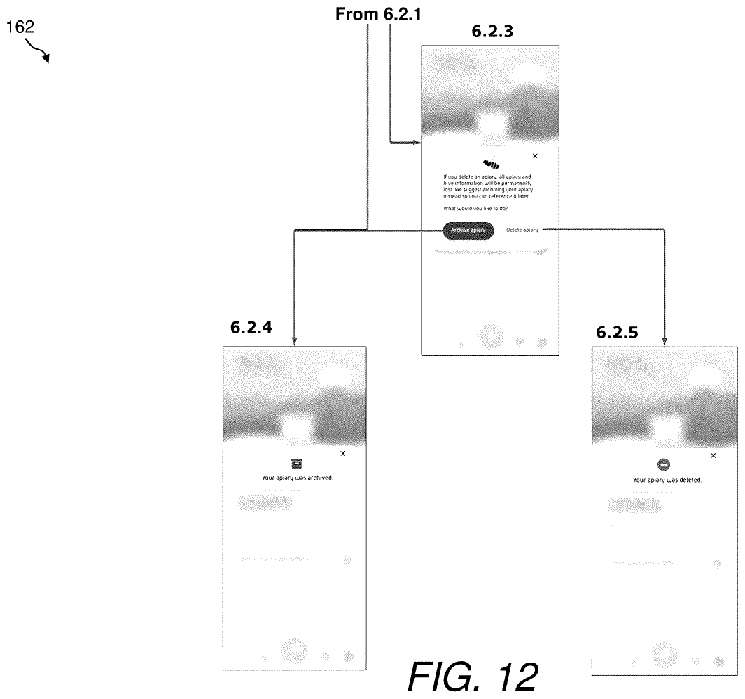

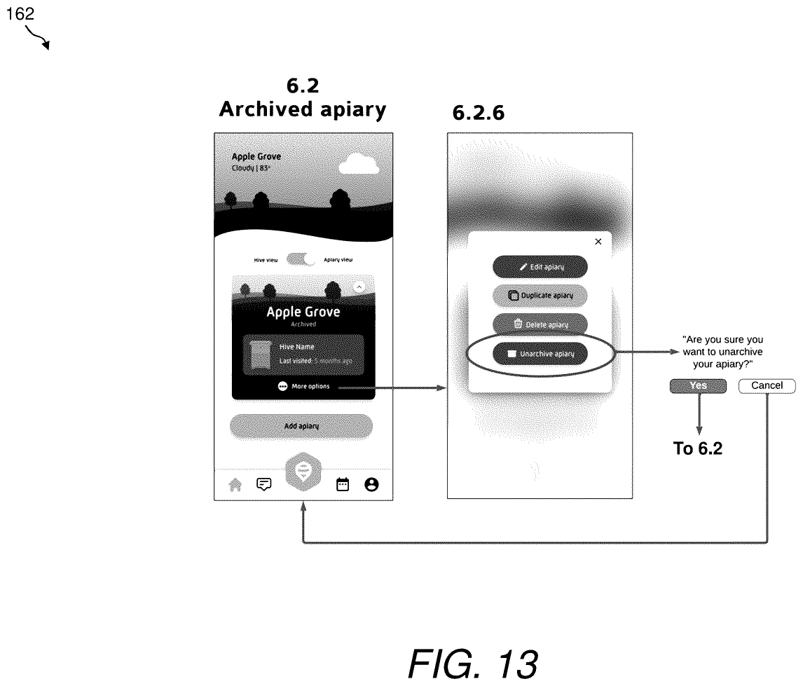

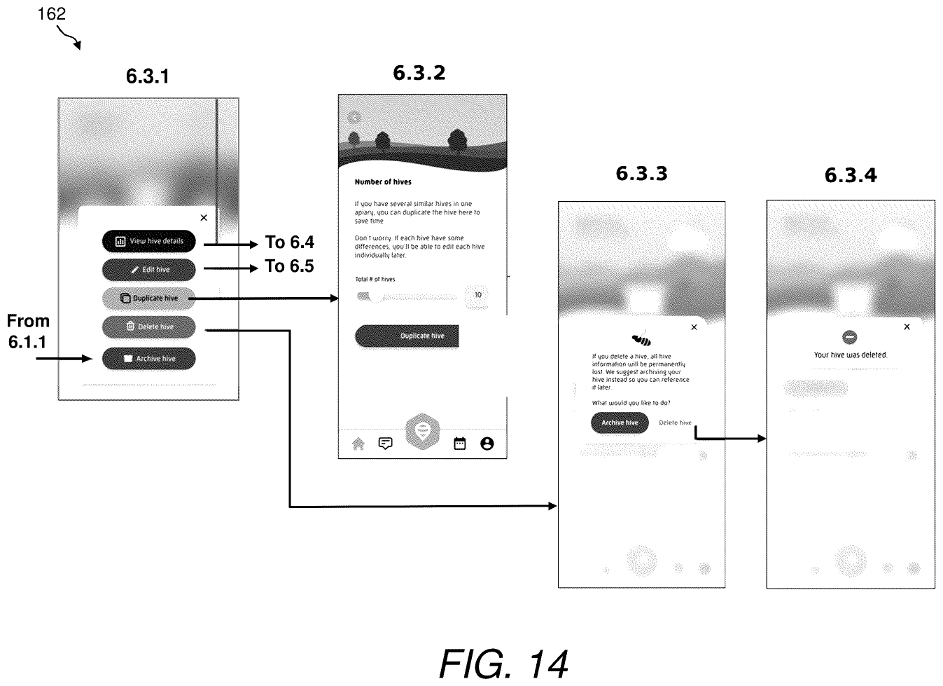

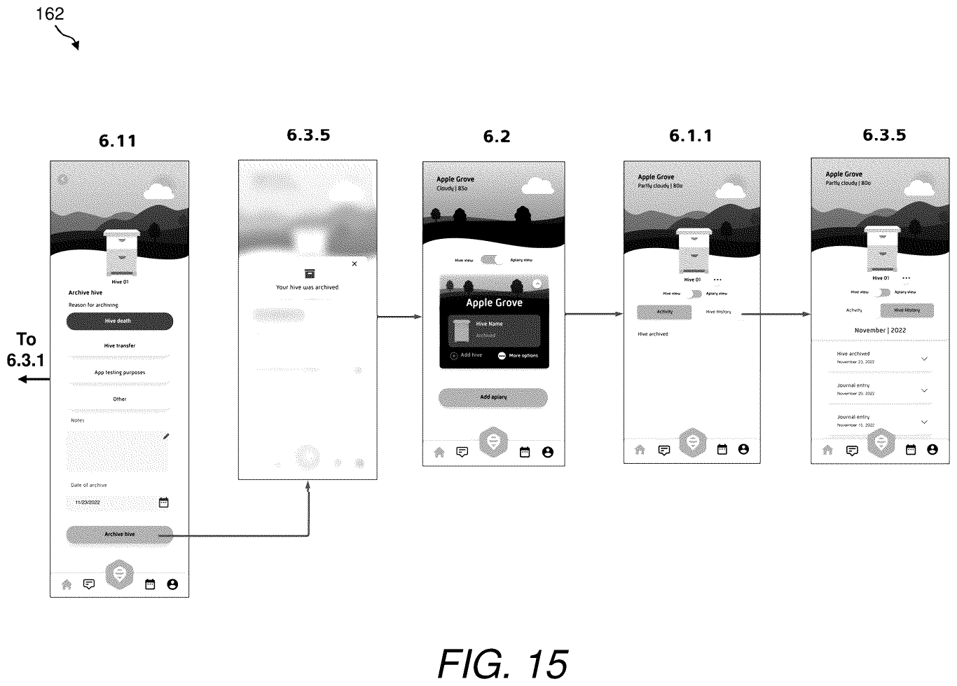

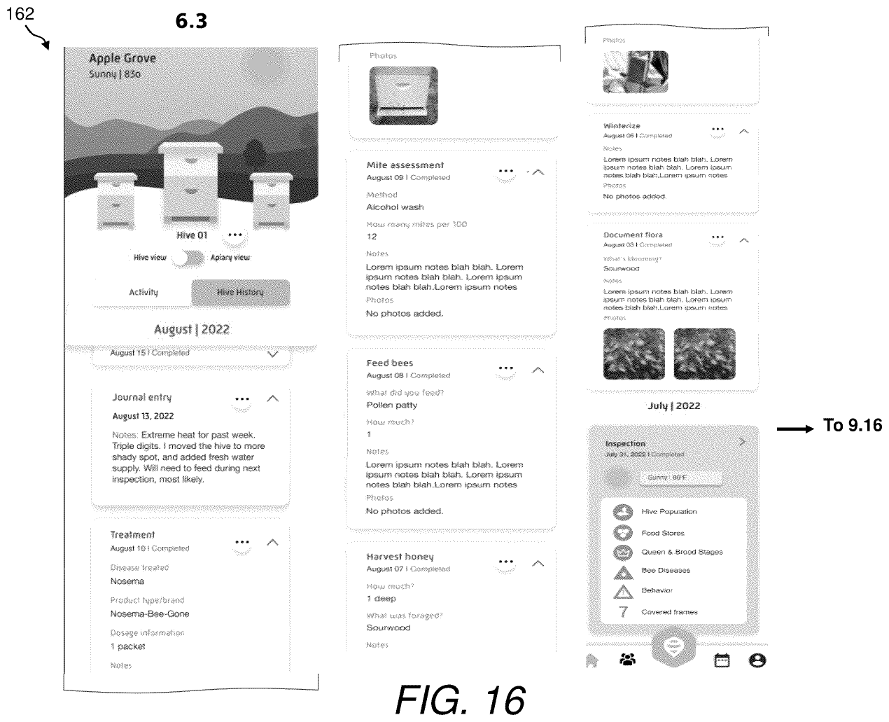

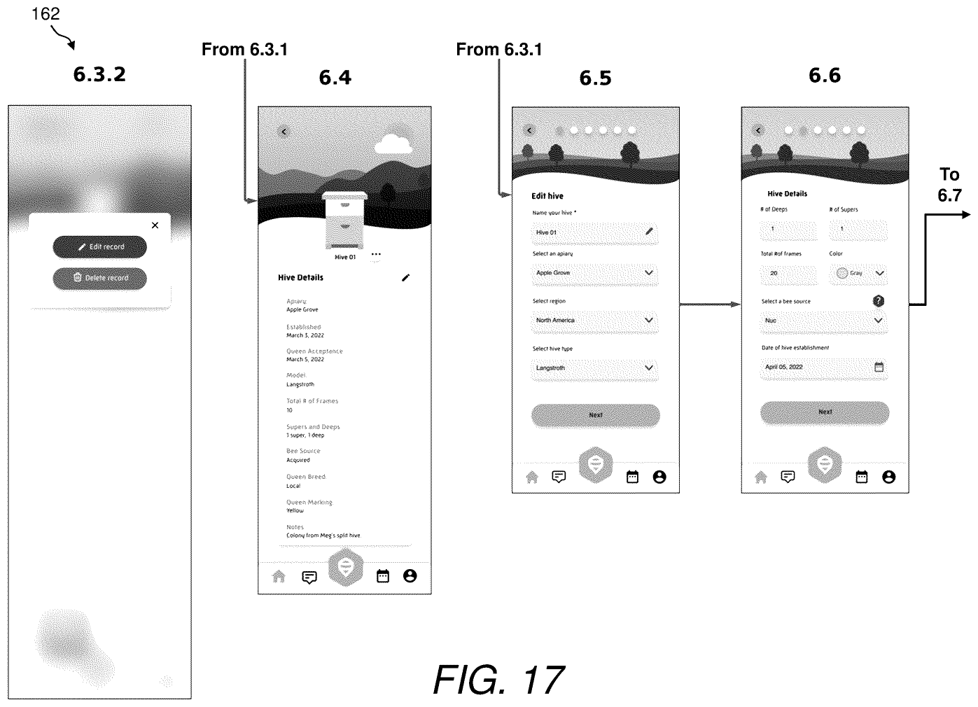

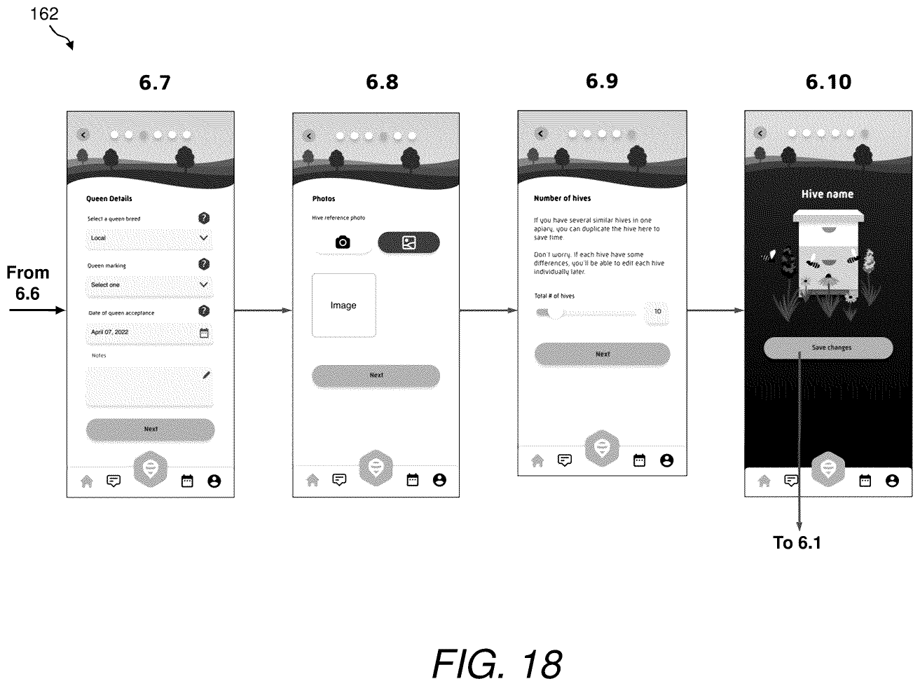

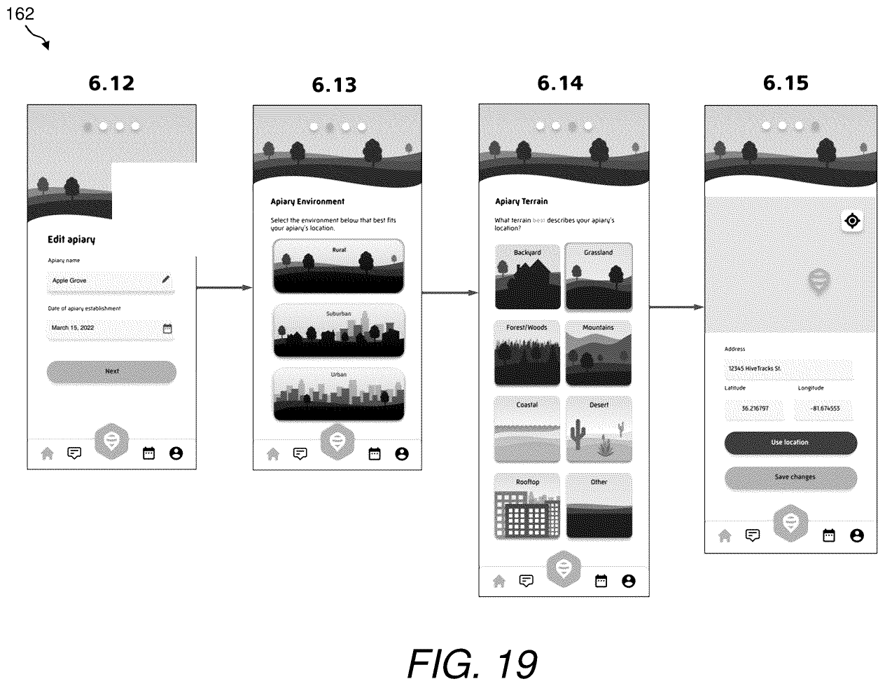

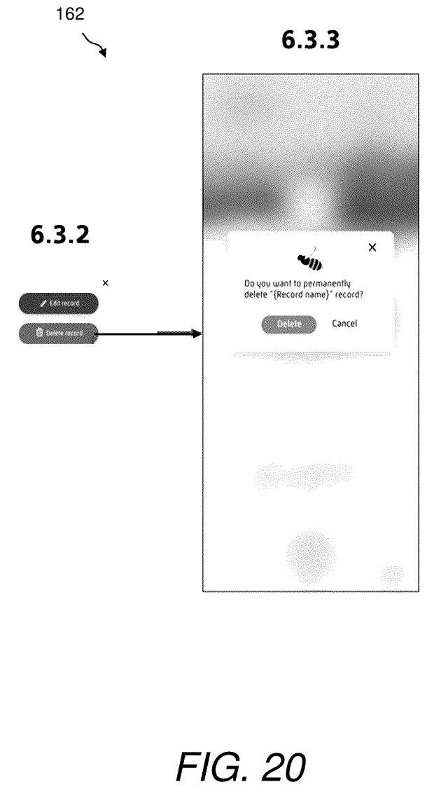

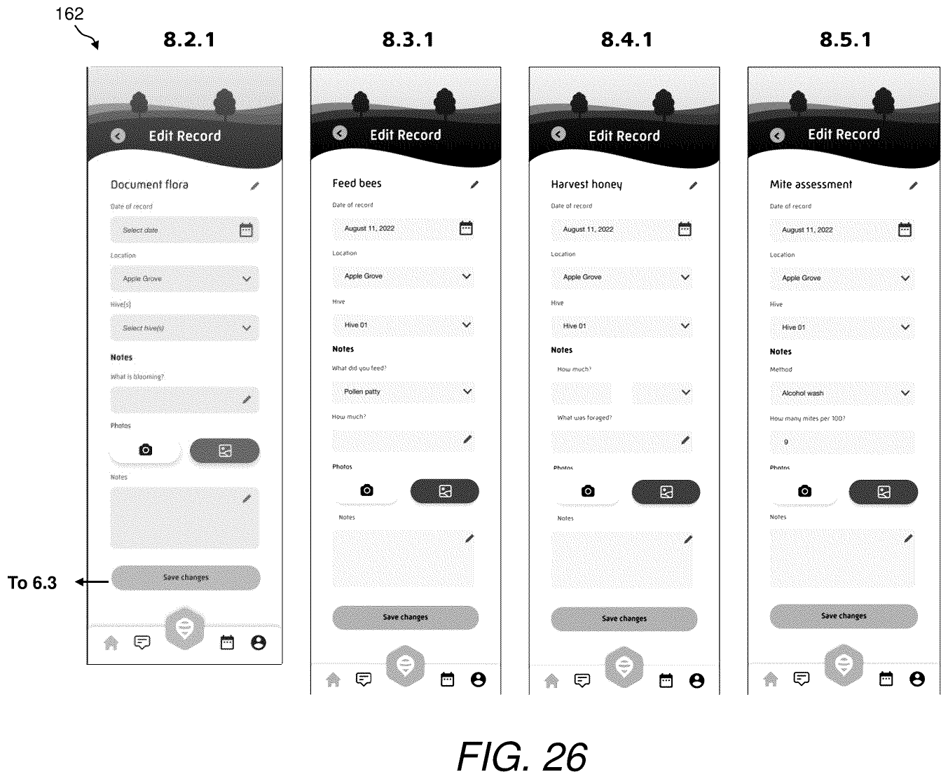

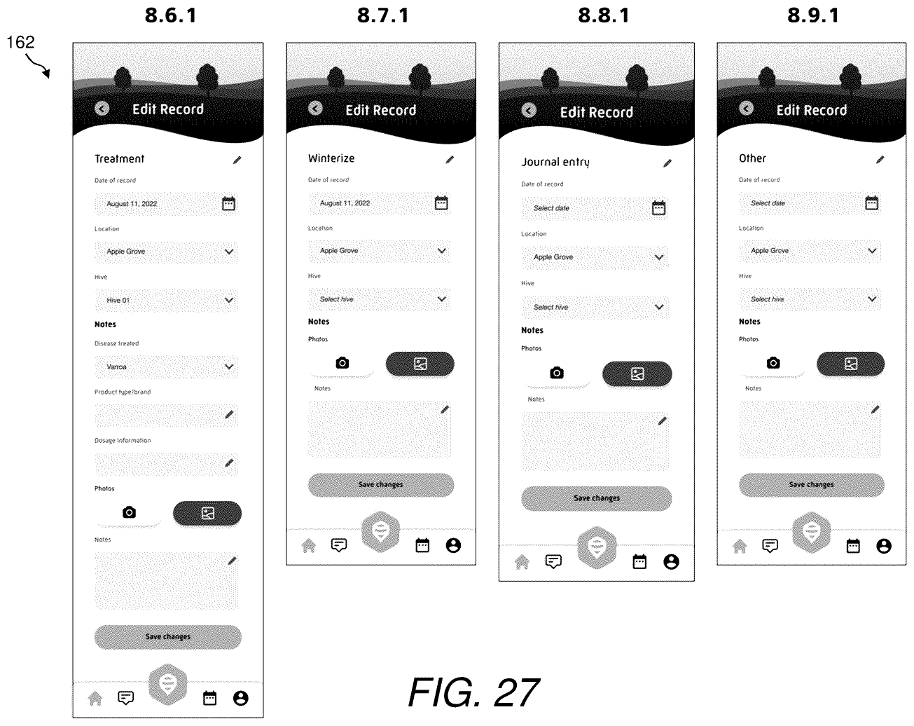

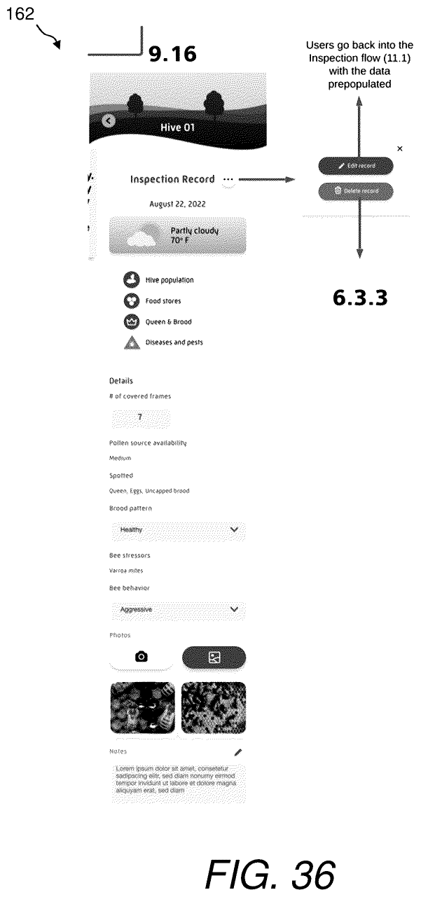

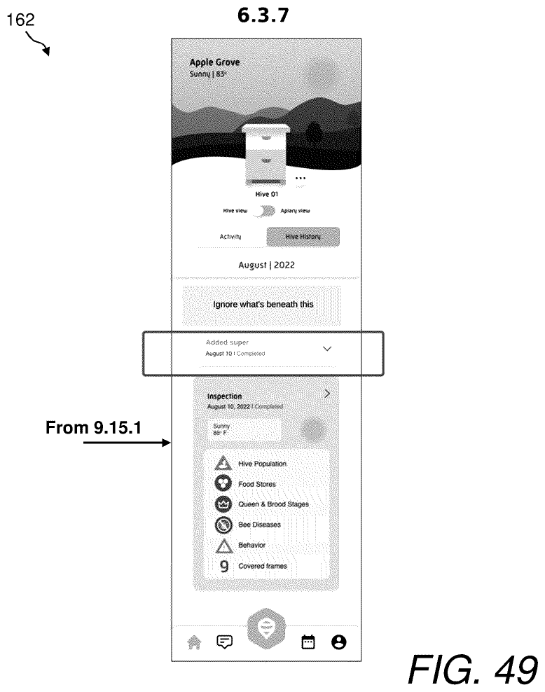

More examples of using hive tracking mobile app 162 of beehive management system 100 to manage beehives are shown and described below in FIG. 2 through FIG. 52.

Referring now to FIG. 2 through FIG. 52 are example screenshots of an example of hive tracking mobile app 162 of beehive management system 100 shown in FIG. 1, in accordance with an embodiment of the invention. In one non-limiting example, hive tracking mobile app 162 may include one or more of:
a set of “Welcome” screens;
a set of “Account Create” screens;
a set of “Apiary Creation” screens;
a set of “Home/Apiary” screens;
a set of “Hive Creation” screens;
a set of “Hive/Apiary” screens;
a set of “To-Dos” screens;
a set of “Records” screens;
a set of “Inspection” screens;
a set of “Calendar” screens;
a set of “Profile” screens;
a set of “Community/Notifications” screens;
a set of “Recommendations” screens; and
a set of “Symptom Checker” screens.

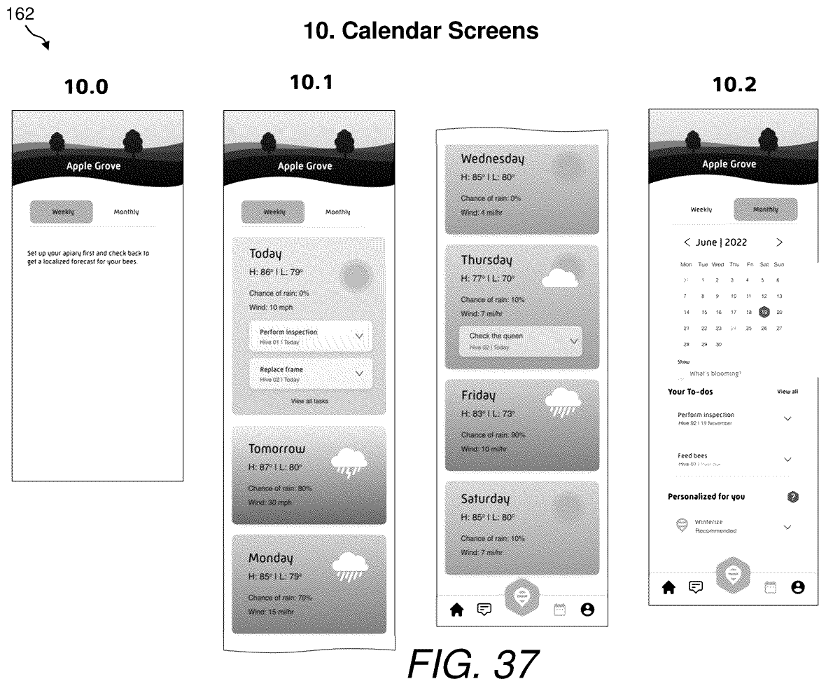

The “Welcome” screens, the “Account Create” screens, the “Apiary Creation” screens, the “Home/Apiary” screens, the “Hive Creation” screens, the “Hive/Apiary” screens, the “To-Dos” screens, the “Records” screens, and the “Inspection” screens shown in FIG. 2 through FIG. 36 may be considered the input side of hive tracking mobile app 162. The “Calendar” screens, the “Profile” screens, the “Community/Notifications” screens, the “Recommendations” screens, and the “Symptom Checker” screens shown in FIG. 37 through FIG. 52 may be considered the output side of hive tracking mobile app 162.

FIG. 2 through FIG. 52 indicate an example of the order and/or flow a beekeeper 105 may use when interacting with hive tracking mobile app 162 of beehive management system 100.

Beginning now with the input side of hive tracking mobile app 162, FIG. 2 shows an example “Welcome” screen of hive tracking mobile app 162.

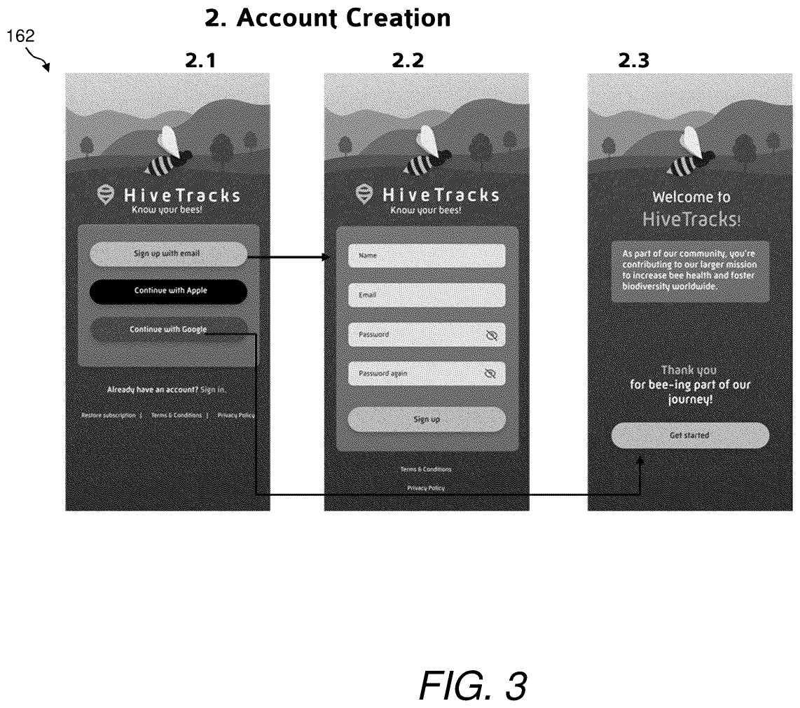

Next, FIG. 3 shows examples of “Account Create” screens of hive tracking mobile app 162 and wherein the screens are labeled beginning with the number 2. Here, a beekeeper 105 may setup/enter login credentials as is well known.

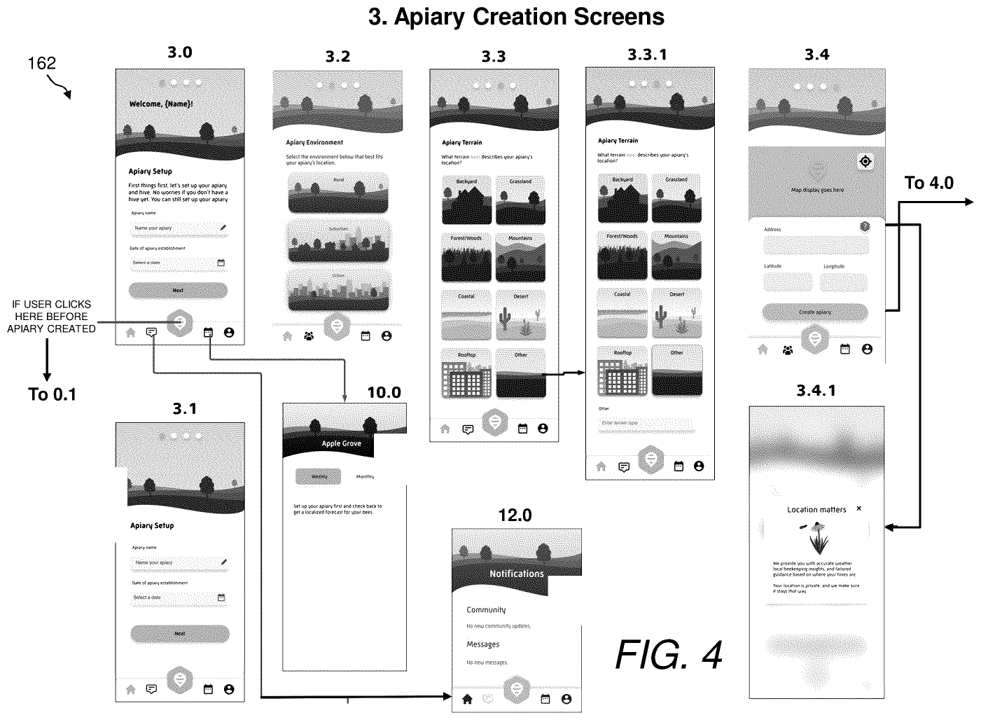

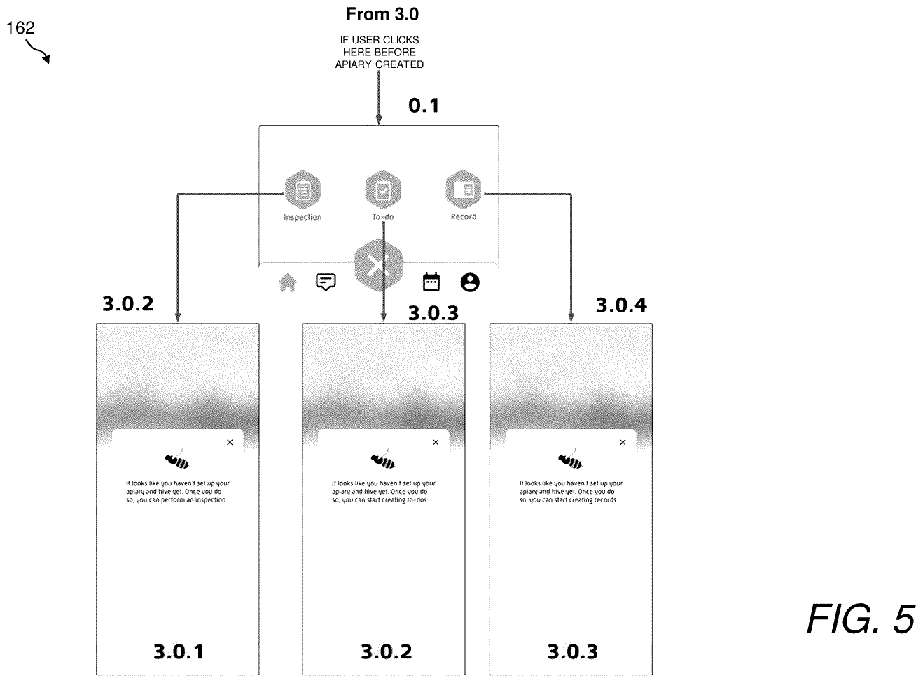

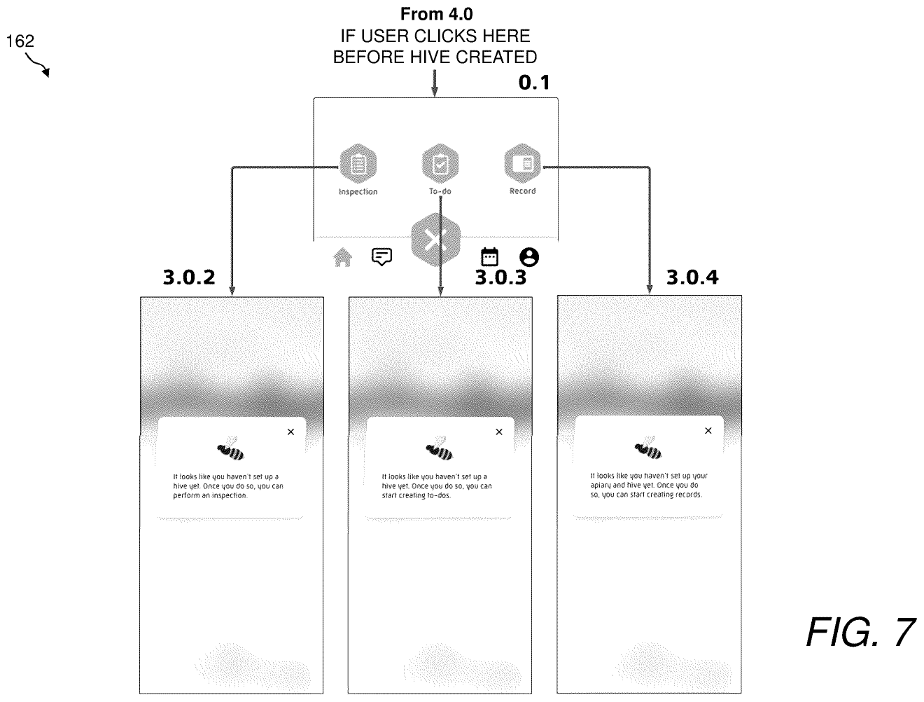

FIG. 4, FIG. 5, and FIG. 7 show examples of “Apiary Creation” screens of hive tracking mobile app 162 and wherein the screens are labeled beginning with the number 3. Here, a beekeeper 105 may create an apiary environment, which is the bee yard. “Apiary” means a location in which multiple beehives may be clustered. Then, the beekeeper 105 may select, for example, the apiary environment and terrain, and input other details, such as, but not limited to, apiary name, date established, location details, and/or other preferences/details.

Next, FIG. 6 shows an example of a “Home/Apiary” screen of hive tracking mobile app 162 and wherein the screen is labeled beginning with the number 4. Here, the beekeeper 105 may, in one example, initiate the addition of an apiary, hive, and/or an address or GPS location.

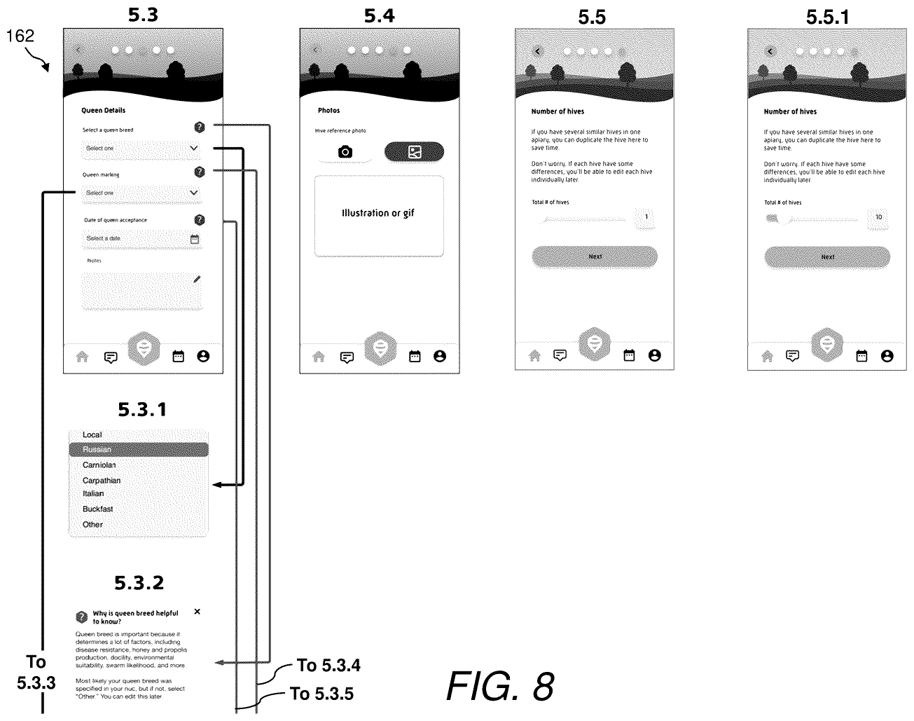

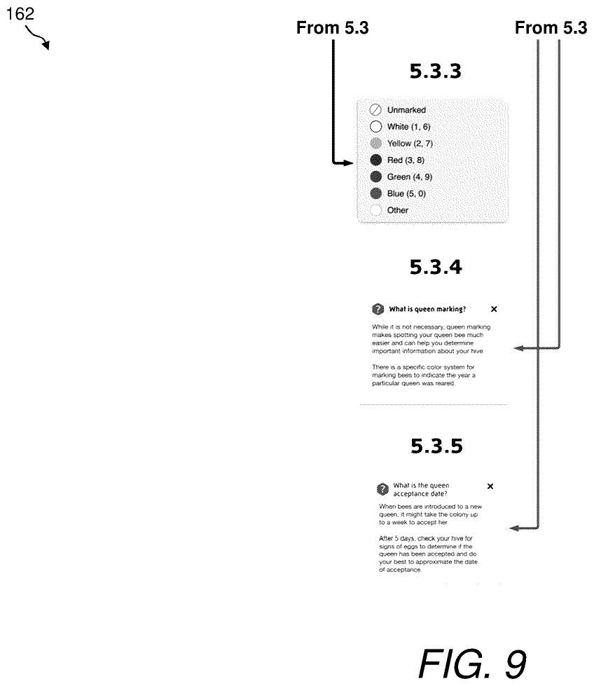

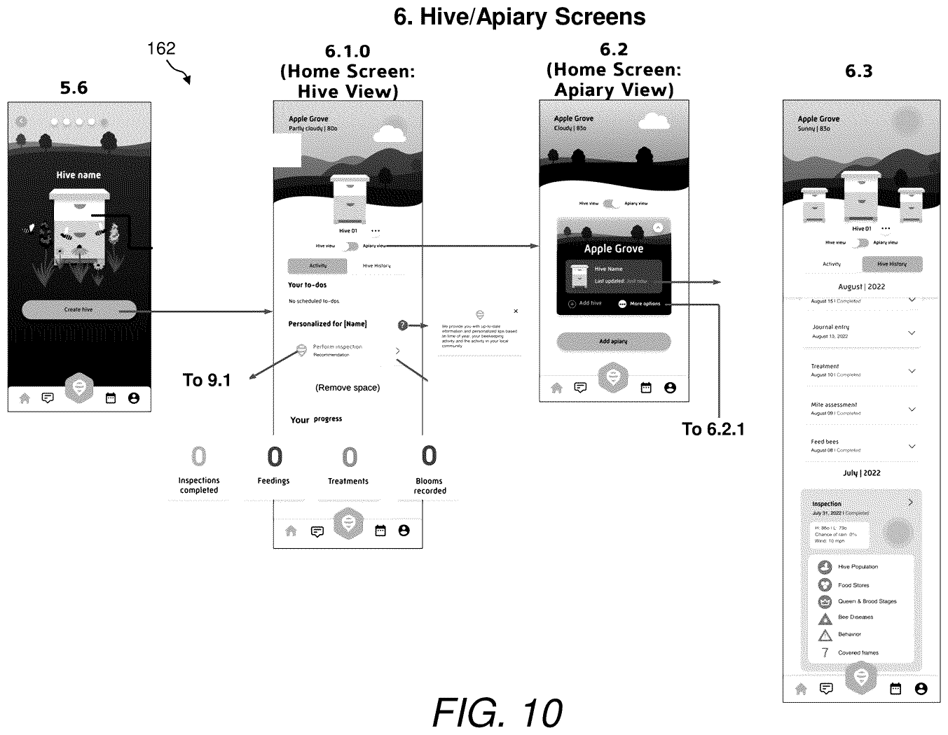

Next, FIG. 6, FIG. 8, FIG. 9, and FIG. 10 show examples of “Hive Creation” screens of hive tracking mobile app 162 and wherein the screens are labeled beginning with the number 5. Here, the beekeeper 105 may set up, enter hive/bee details, and/or configure the hive, which may be any type of hive depending on the preferences of the beekeeper 105. Here, the beekeeper 105 may enter the hive details, such as, but not limited to, name, apiary, region, date established, type, number, bee details, queen details, photos, and/or the like. Hive configuration may mean, for example, how tall, how large, the color, where the bees come from, and so on. Also, the beekeeper 105 may set the number of hives in the apiary.

Next, FIG. 10 through FIG. 20 show examples of “Hive/Apiary” screens of hive tracking mobile app 162 and wherein the screens are labeled beginning with the number 6. Here, the beekeeper 105 may be taken to the hive/apiary home page shown, for example, of FIG. 11 and screen 6.1. The “Hive/Apiary” screens may show apiary location, apiary name, number of hives, weather data, a To-Dos selection, a recommendations selection, a community recommendations selection, and/or other related data. The “Hive/Apiary” screens may also allow for toggling between a hive view and apiary view. Screen 6.1.2 of FIG. 11 shows additional data points indicating operational data (e.g., inspections, feeding, treatments, blooms recorded, etc.).

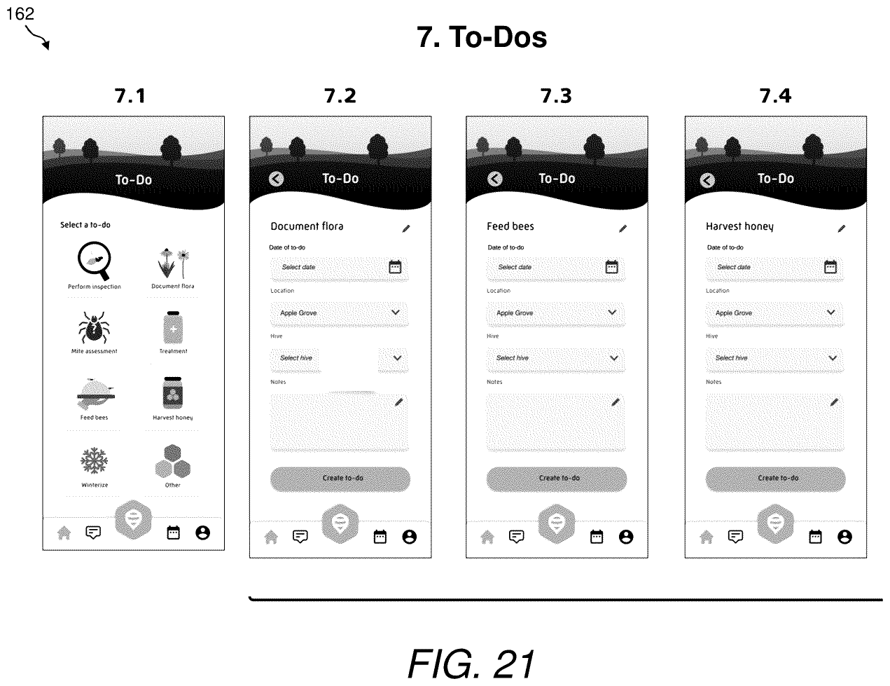

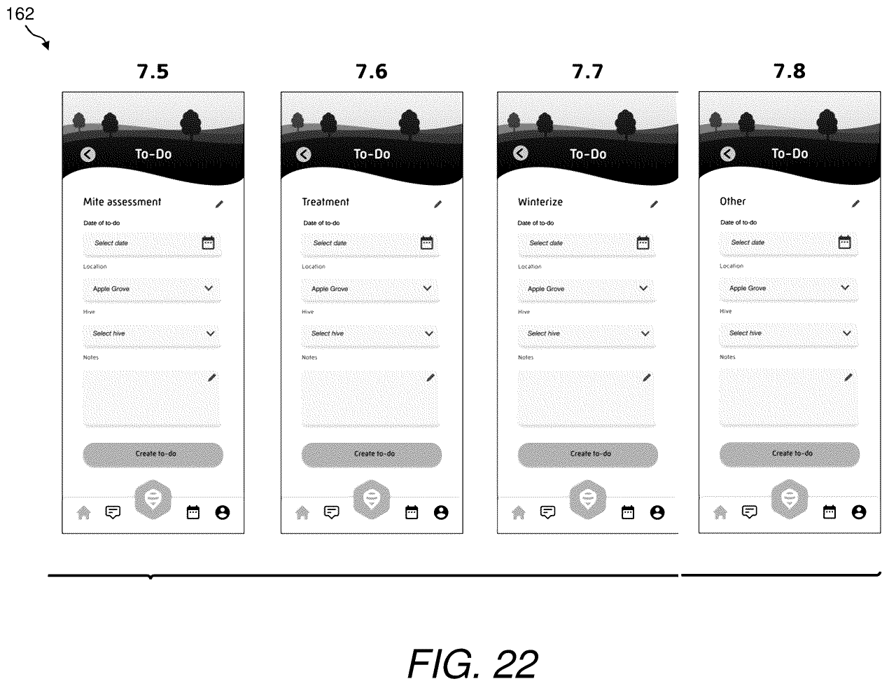

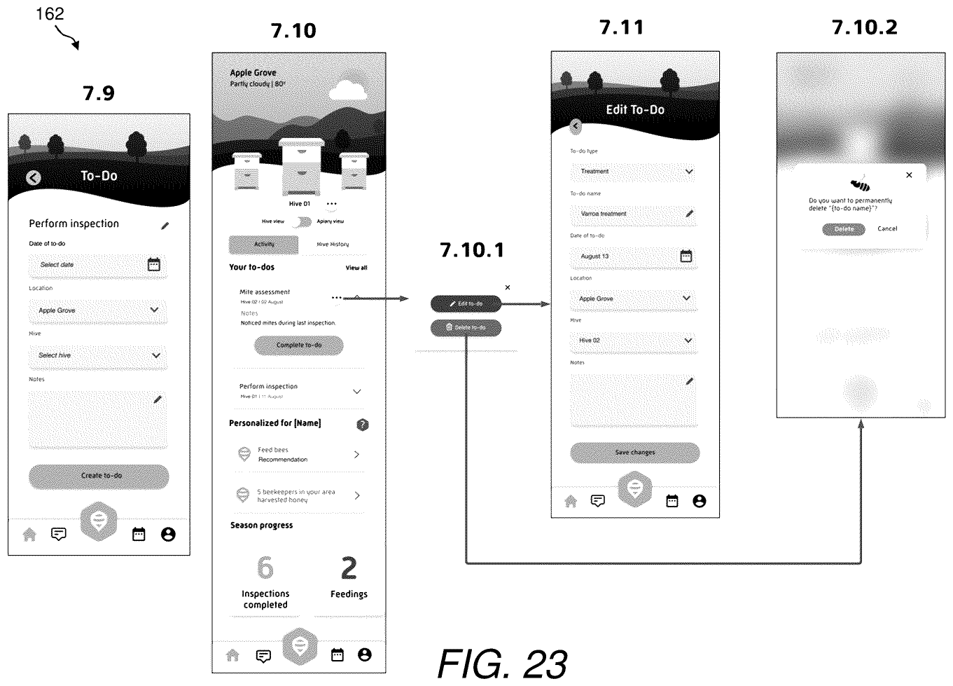

Next, FIG. 21, FIG. 22, and FIG. 23 show examples of “To-Dos” screens of hive tracking mobile app 162 and wherein the screens are labeled beginning with the number 7. Here, “To-Dos” means actions that a beekeeper 105 may perform. For example, screens 7.1, 7.2, 7.3, 7.4, 7.5, 7.6, 7.7, 7.8 and 7.9 of FIG. 21, FIG. 22, and FIG. 23 show examples of tasks. Tasks may include, for example but not limited to, document flora, feed bees, harvest honey, mite assessment, treatment, winterize, other, and/or perform inspection. The “To-Dos” may be selected, scheduled, deleted, and/or edited by the beekeeper 105 him/herself. The beekeeper 105, may also add notes related to the To-Dos.

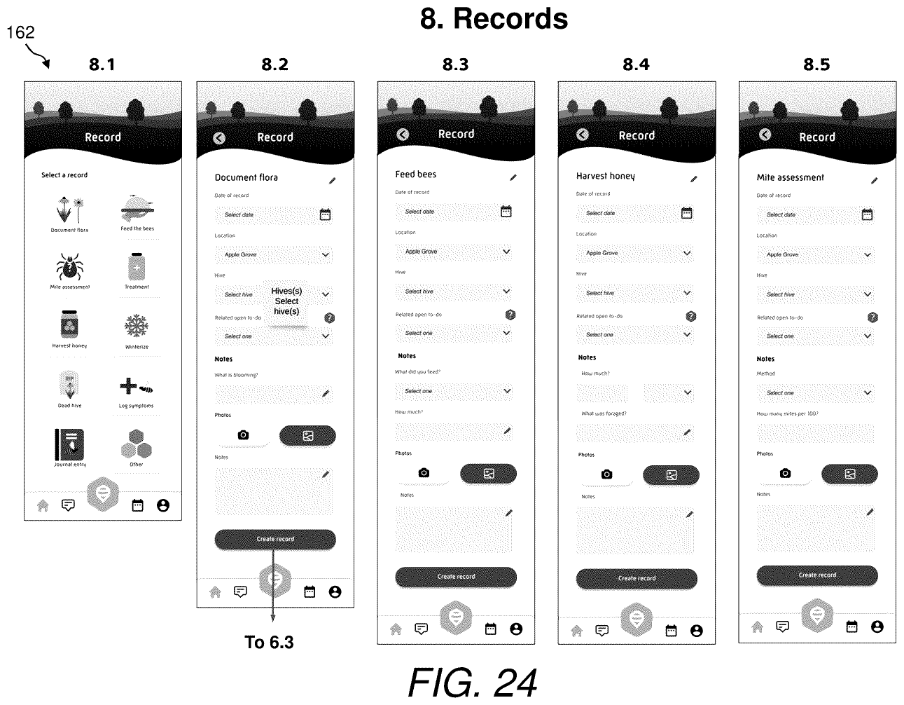

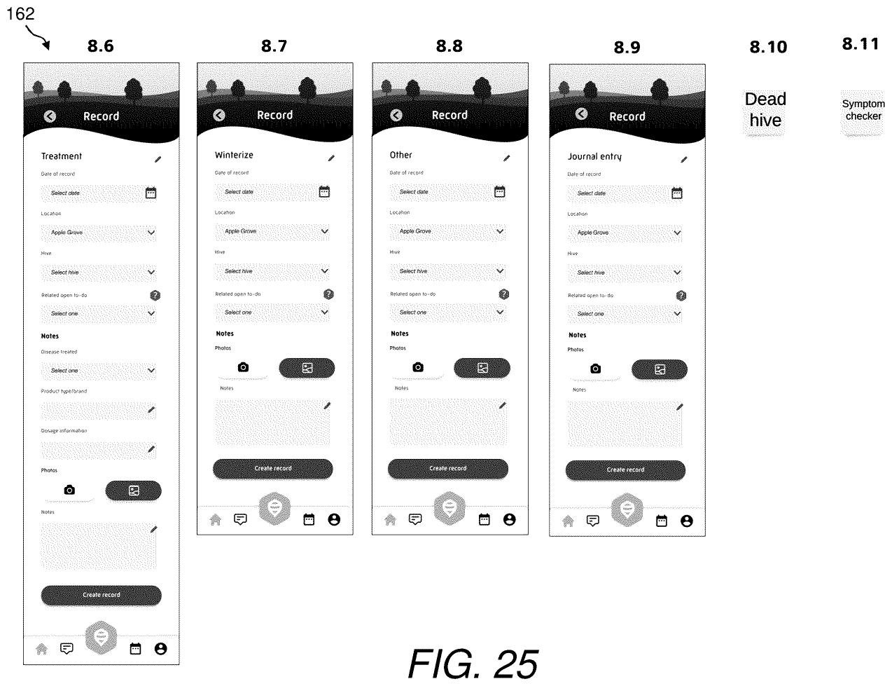

Next, FIG. 24 through FIG. 27 show examples of “Records” screens of hive tracking mobile app 162 and wherein the screens are labeled beginning with the number 8. For example, screens 8.1, 8.2, 8.3, 8.4, 8.5, 8.6, 8.7, 8.8 and 8.9 of FIG. 24 and FIG. 25 show non-limiting examples of records.

Here, when a beekeeper 105 performs an unscheduled task (i.e., an ad hoc action) or a task is performed that is not scheduled (i.e., a hive dies, symptoms observed), this task (as well as any tasks) and the associated details of the task may be documented using the “Records” screens. Each of the records may have both generic data (e.g., when, where) and specific data entry fields. For example, if the bees were fed, the beekeeper 105 may be prompted for how much was fed, what was fed, and so on. If honey was harvested, the beekeeper 105 may be prompted for how much was harvested, what was foraged, and so on. Other details and/or data points, such as any related open to-do, notes, photos, etc.

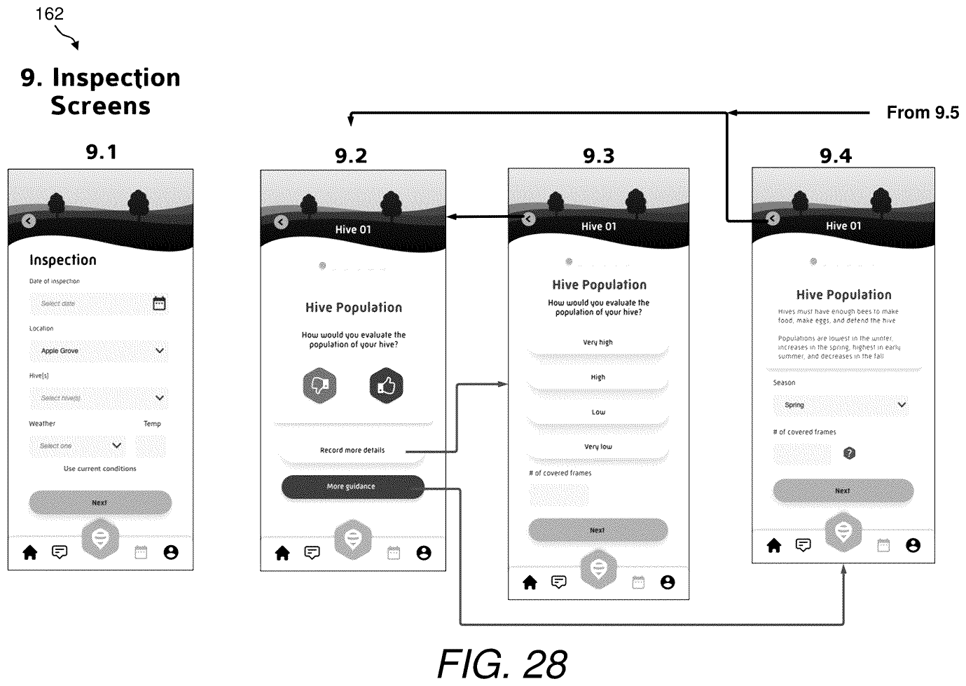

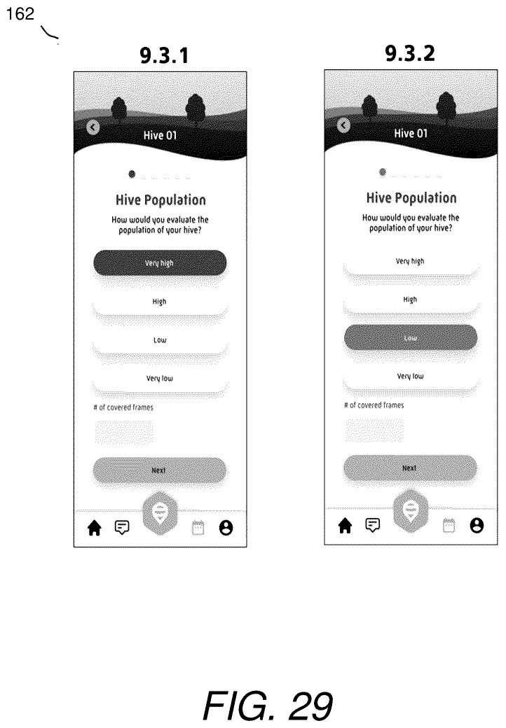

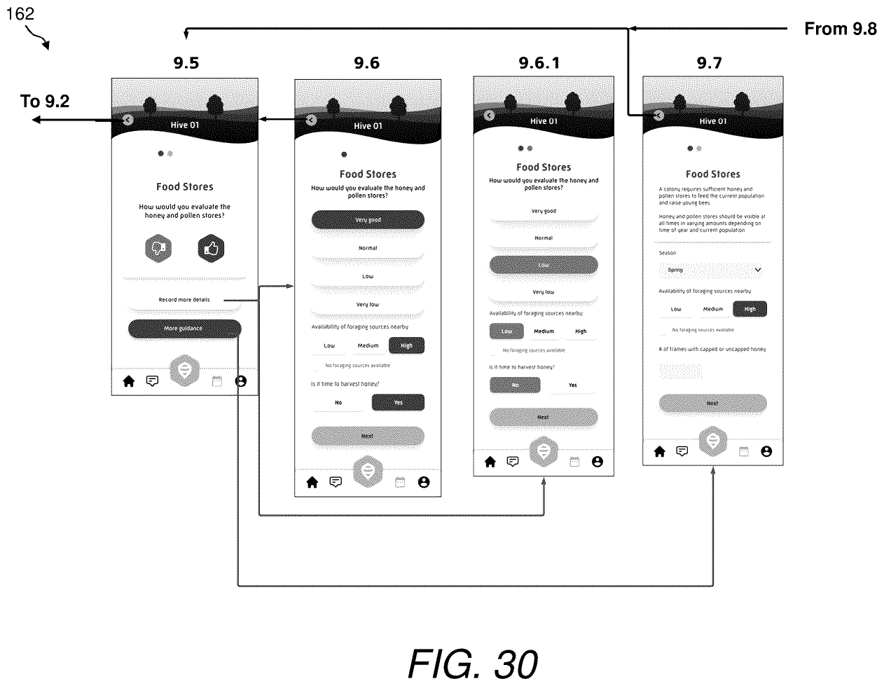

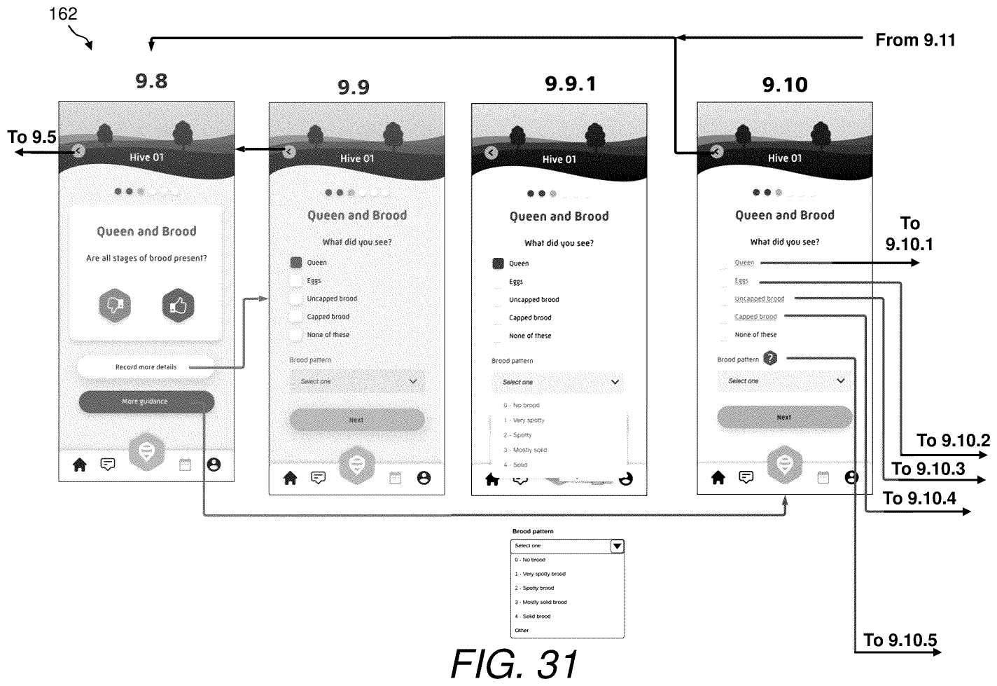

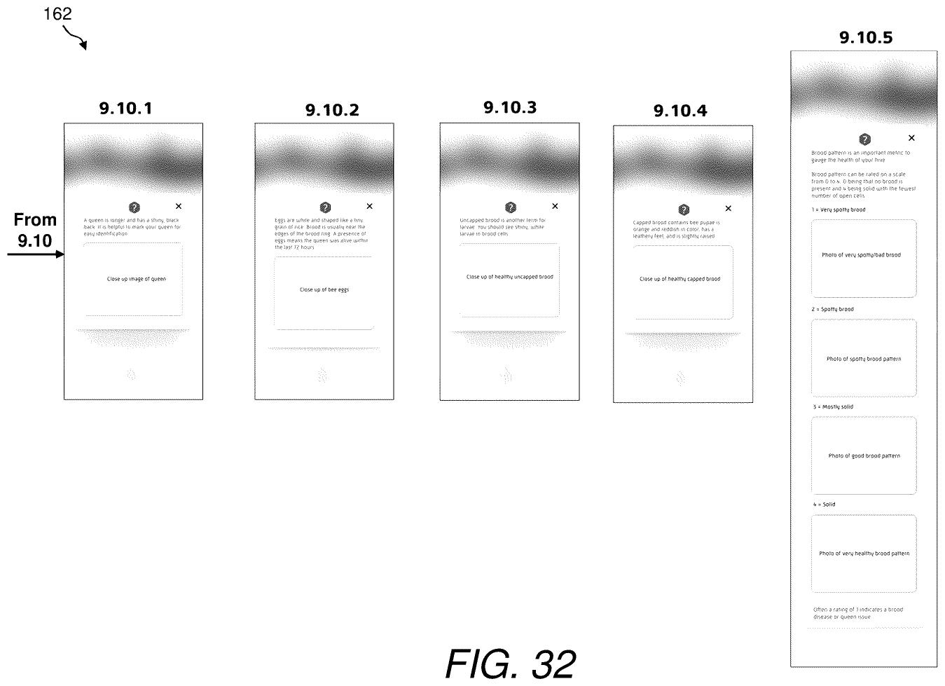

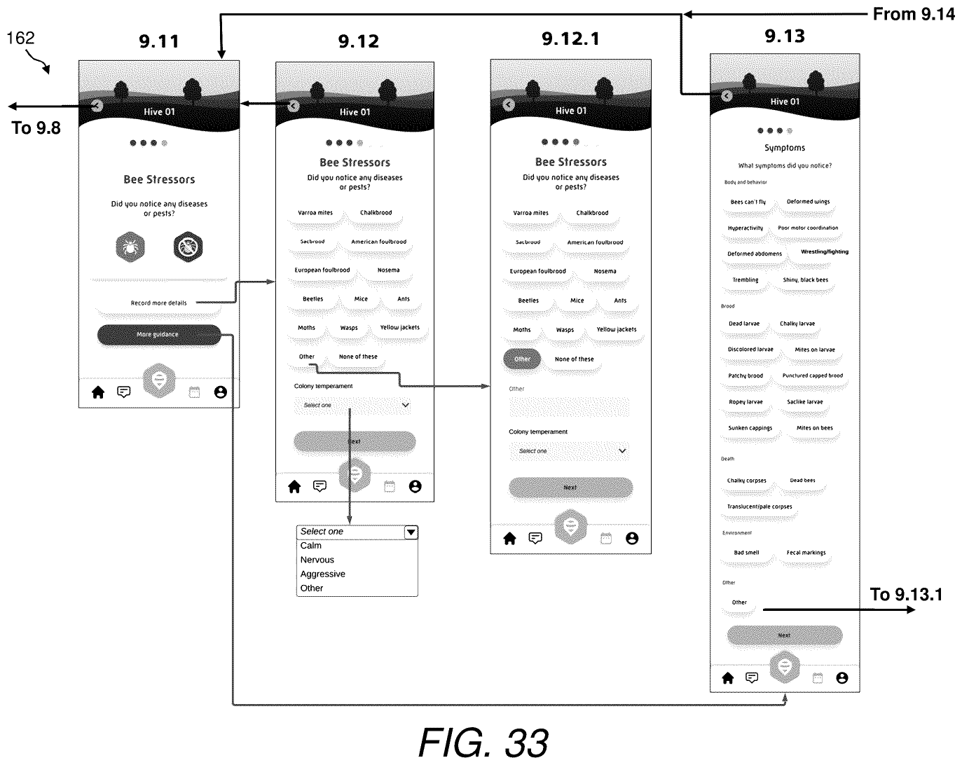

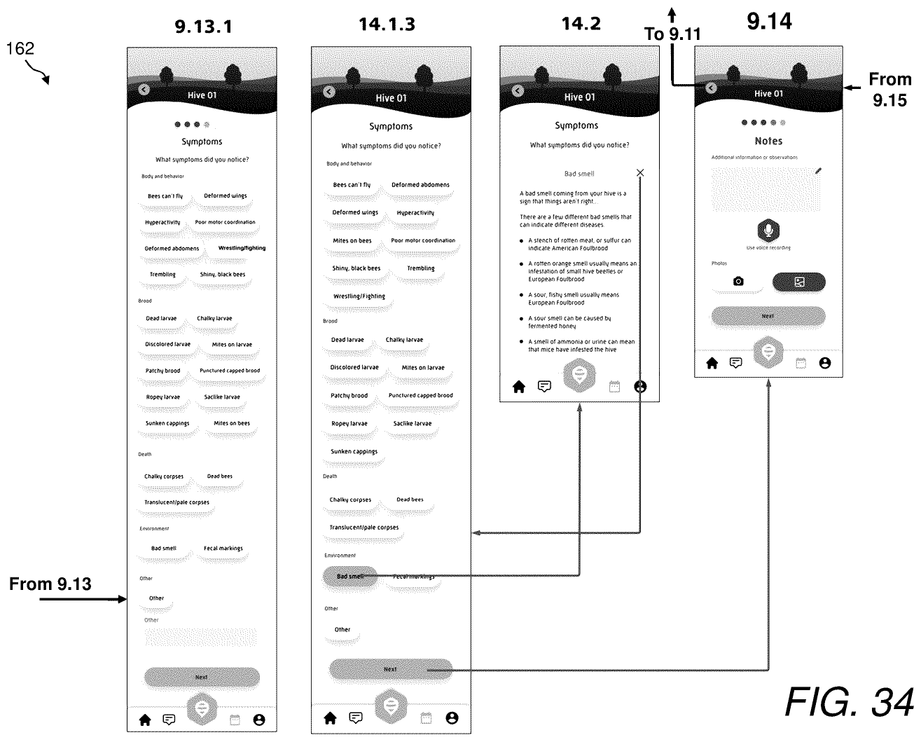

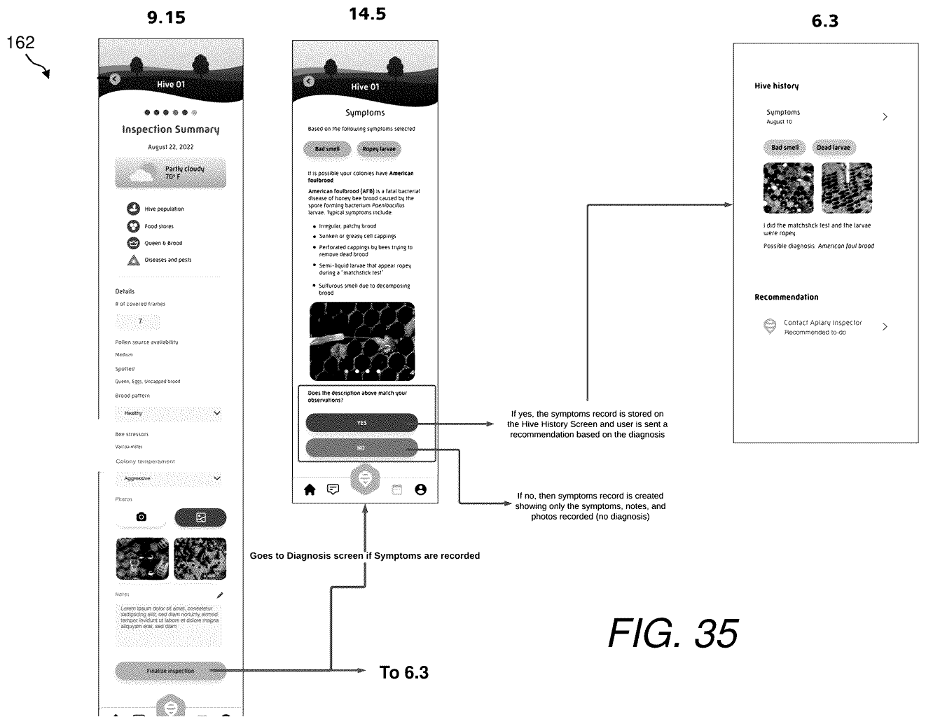

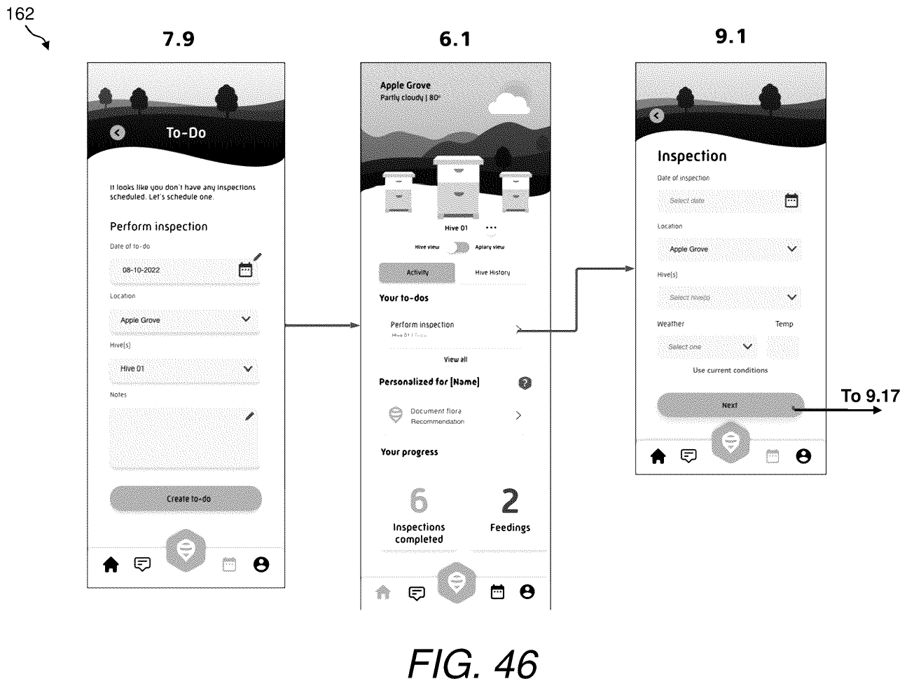

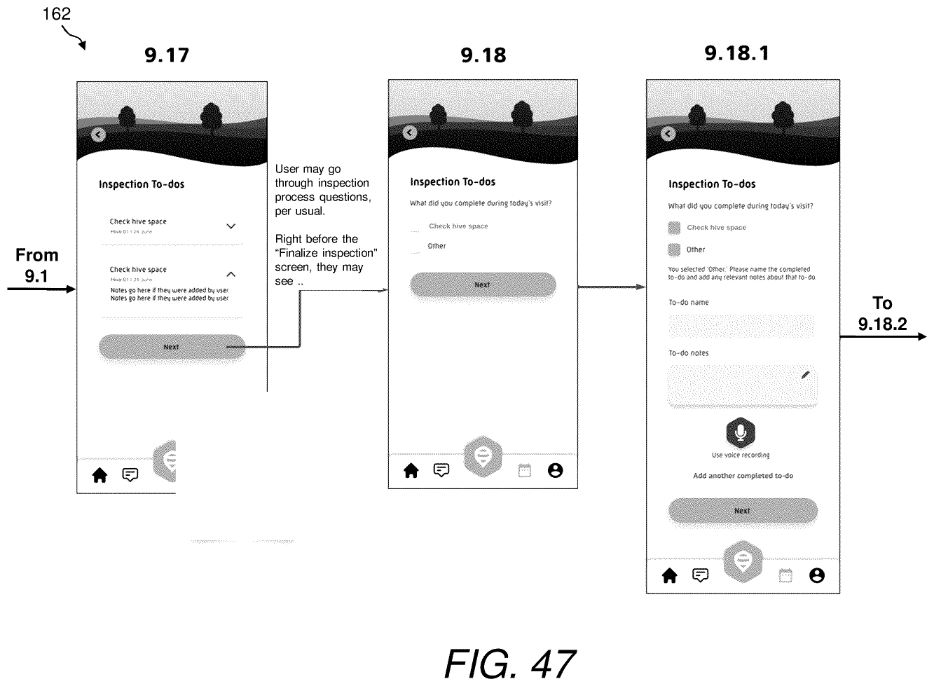

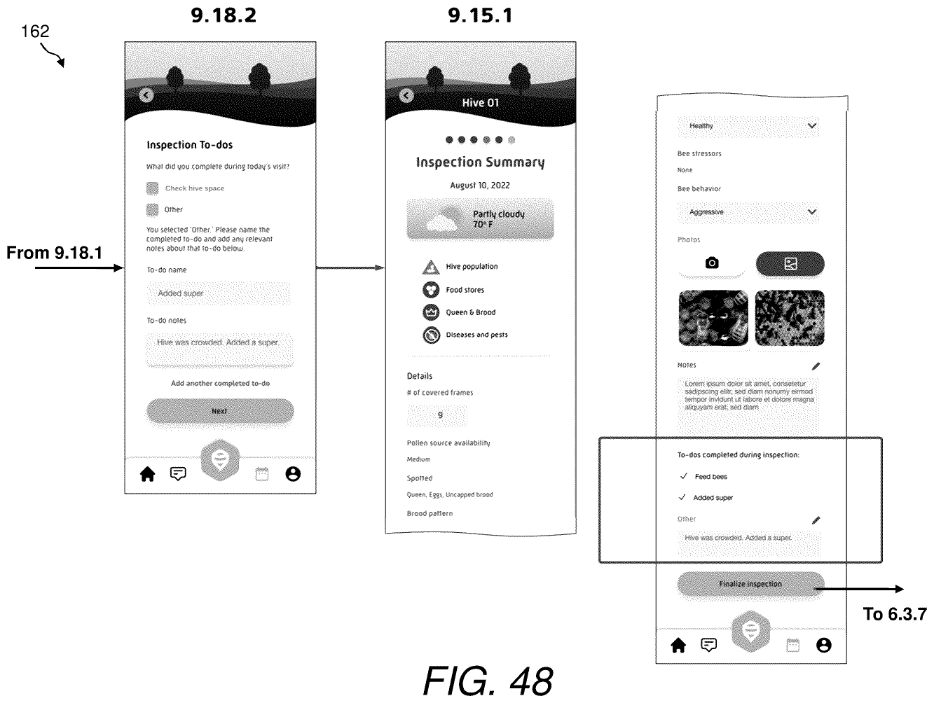

FIG. 28 through FIG. 36, and FIG. 46, FIG. 47, and FIG. 48 show examples of “Inspection” screens of hive tracking mobile app 162 and wherein the screens are labeled beginning with the number 9. The “Inspection” screens are used to perform the health assessment of the beehives and wherein an inspection summary may be shown in screen 9.15 of FIG. 35. The health assessment may be based on:
(1) information about the status or size of the hive population (see screens of FIG. 28 and FIG. 29). Can be indicated multiple ways.
(2) information about the presence and condition of food stores (see screens of FIG. 30);
(3) information about the presence and condition of the queen and brood stages (see screens of FIG. 31 and FIG. 32), and
(4) information about diseases and stressors, including, for example, potential symptoms (see screens of FIG. 33 and FIG. 34). Here, the beekeeper 105 may record the disease if known using screens 9.12 and 9.12.1 of FIG. 33. Also, the beekeeper 105 may record the symptoms if the beekeeper 105 is unsure of the disease using screen 9.13 of FIG. 33 and screens 9.13.1, 14.1.3, and 14.2 of FIG. 34. Further, based on the symptoms recorded, recommendation engine 112 may be used to determine the disease and/or stressor and then make a recommendation for treatment, as shown for example in FIG. 35, screens 14.5 and 6.3.

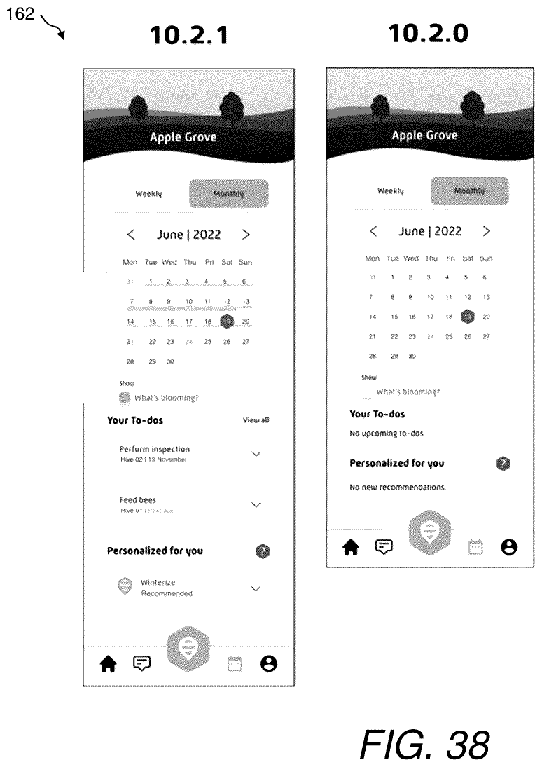

Next, FIG. 37 and FIG. 38 show examples of “Calendar” screens of hive tracking mobile app 162, and wherein the screens are labeled beginning with the number 10. Here, a calendar view may be provided that allows the beekeeper 105 to view, for example, blooming (and/or other like) information, To-Dos, historic events, weather information, general beekeeping activities that may be timed, for example, on the most favorable weather information, recommendations, and/or the like.

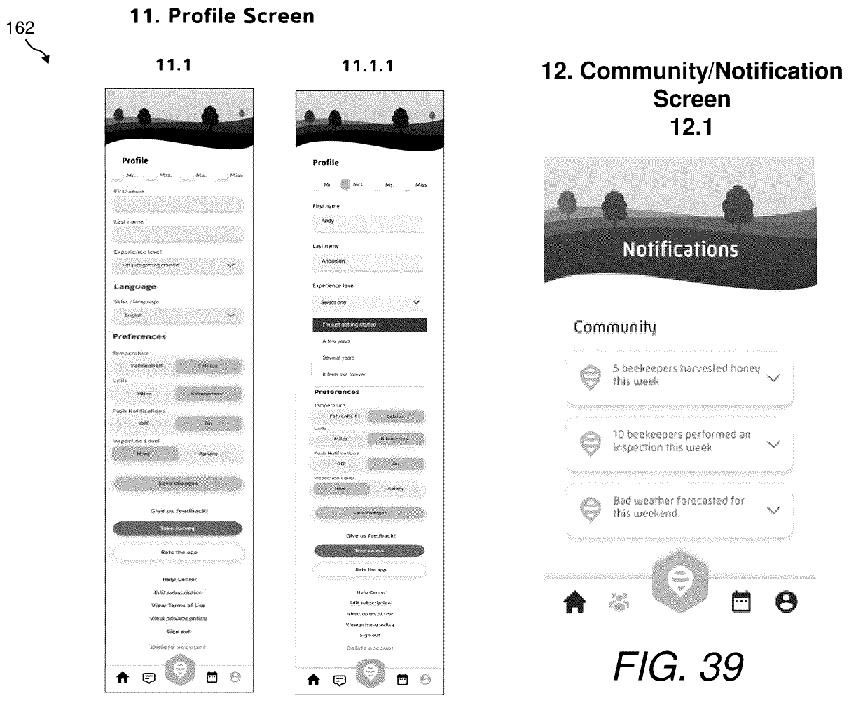

Next, FIG. 39 shows examples of “Profile” screens of hive tracking mobile app 162 and wherein the screens are labeled beginning with the number 11. “Profile” screens may include information related to a user's (e.g., beekeeper) particular details and/or preferences, and may also allow them to enter and or edit such information.

Next, FIG. 39 also shows an example of a “Community/Notification” screen of hive tracking mobile app 162 and wherein the screen is labeled beginning with the number 12. Further, FIG. 40 through FIG. 45 show examples of “Recommendations” screens of hive tracking mobile app 162 and wherein the screens are labeled beginning with the number 13.

Information of the “Community/Notification” screens and the Recommendations” screens, in one example, may work with the logic of recommendation engine 112. For example, when a beekeeper 105 clicks on any of the selections of the notifications screen 12.1 of FIG. 39, hive tracking mobile app 162 may go to the “Recommendations” screens shown in FIG. 40 through FIG. 45.

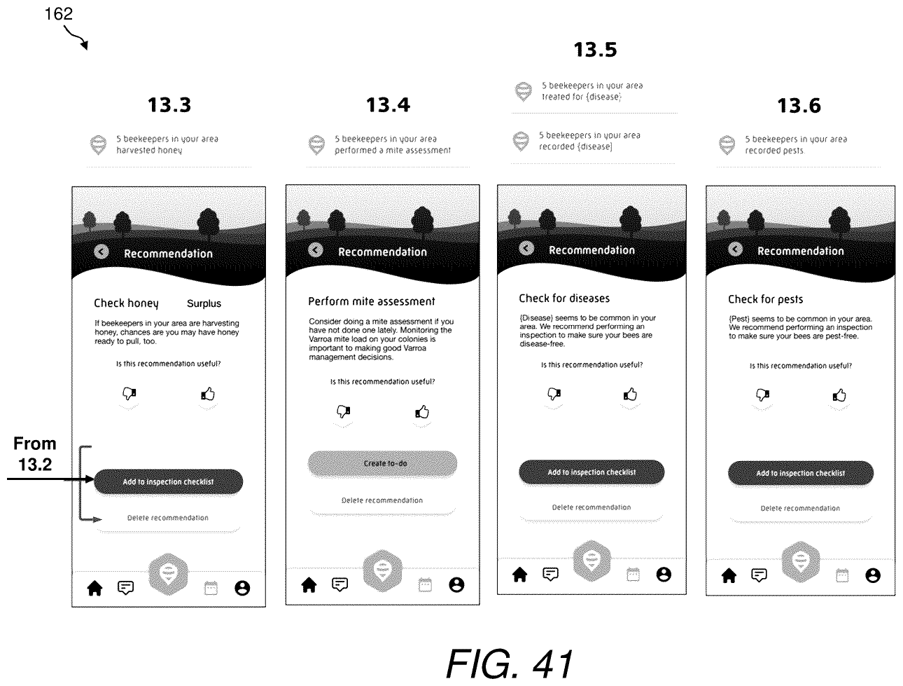

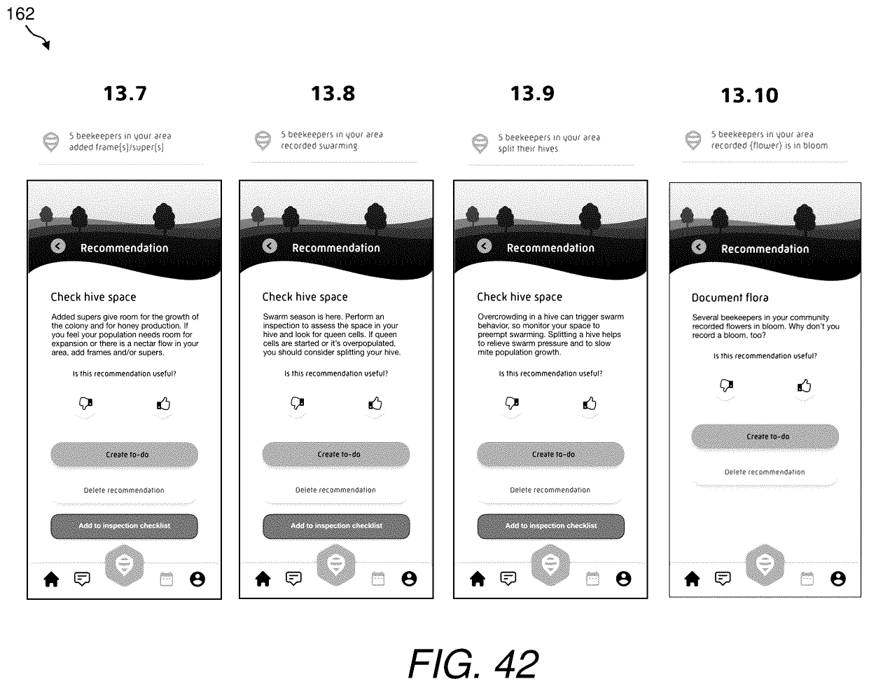

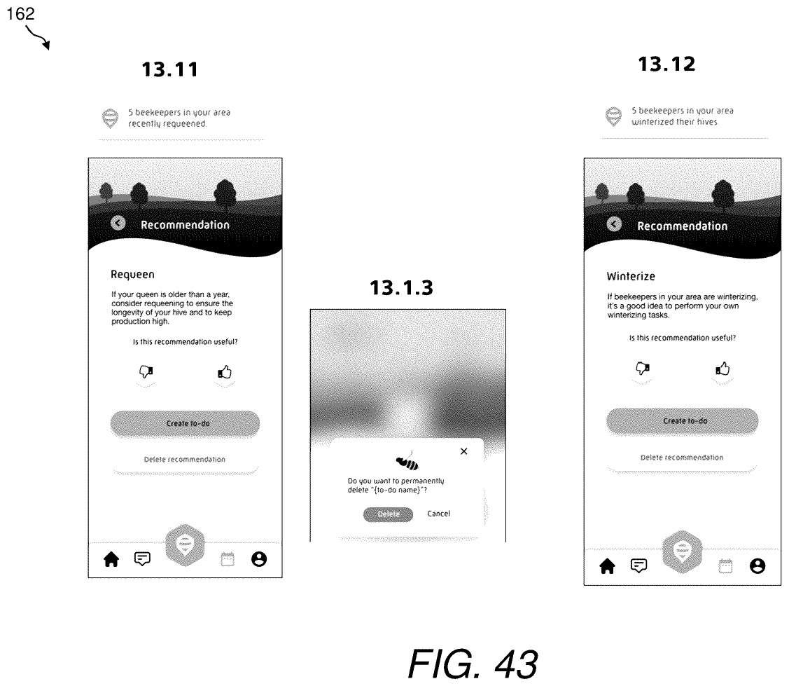

Each of the “Recommendations” screens has a name of the recommendation and a prompt. Further, the prompt may be customized based on the inspection data that indicates certain conditions present. In one non-limiting example, the “Recommendations” screens may include a “Feed bees” screen 13.1 of FIG. 40, a “Perform inspection” screen 13.2 of FIG. 40, a “Check honey” screen 13.3 of FIG. 41, a “Perform mite assessment” screen 13.4 of FIG. 41, a “Check for diseases” screen 13.5 of FIG. 41, a “Check for pests” screen 13.6 of FIG. 41, “Check hive space” screens 13.7, 13.8, 13.9 of FIG. 42, a “Document flora” screen 13.10 of FIG. 42, a “Requeen” screen 13.11 of FIG. 43, and/or a “Winterize” screen 13.12 of FIG. 43.

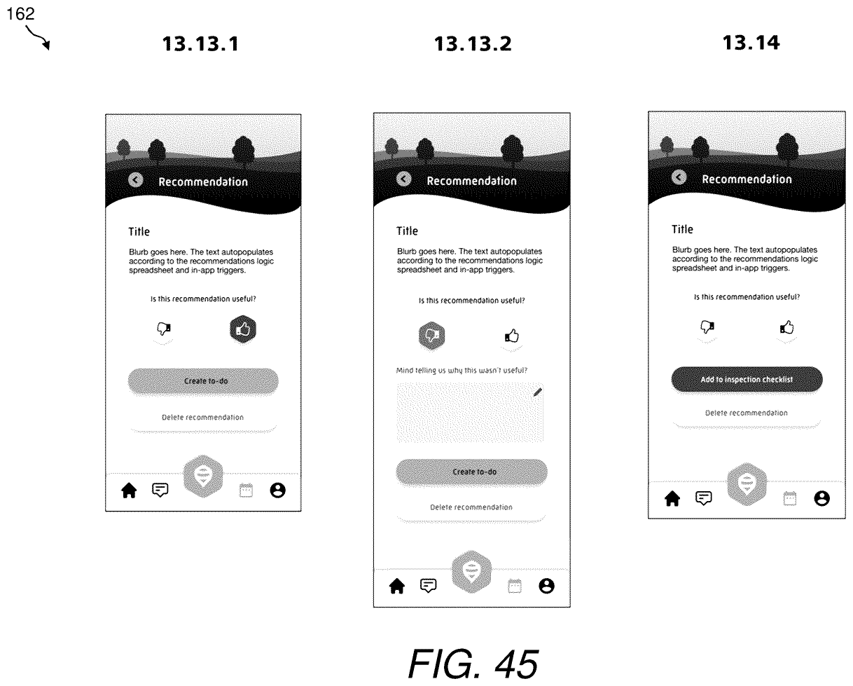

For any recommendation, the beekeeper 105 may create a To-Do item, may rate the recommendation (e.g., thumb up, thumb down). Further, the recommendation may be either accepted and implemented or dismissed and deleted. Using the “Recommendations” screens, the recommendation may show up when selected and contains an actionable title (see FIG. 40 through FIG. 44), an explanation text for why they received the recommendation, a means to rate the recommendation positive or negative, including a comment/note section. The screen (see FIG. 45) may contain options to accept the recommendation or to dismiss it. If dismissed, the recommendation may disappear following a confirmation prompt. If accepted the To-Do screen pops up (see FIG. 46) that allows beekeeper 105 to schedule a date and select a corresponding date for the specific task to be carried out. The beekeeper 105 may also enter the outcome of carrying out any of the recommendations and/or other notes/comments. As soon as that is done, the recommendation disappears from the recommendation screen.

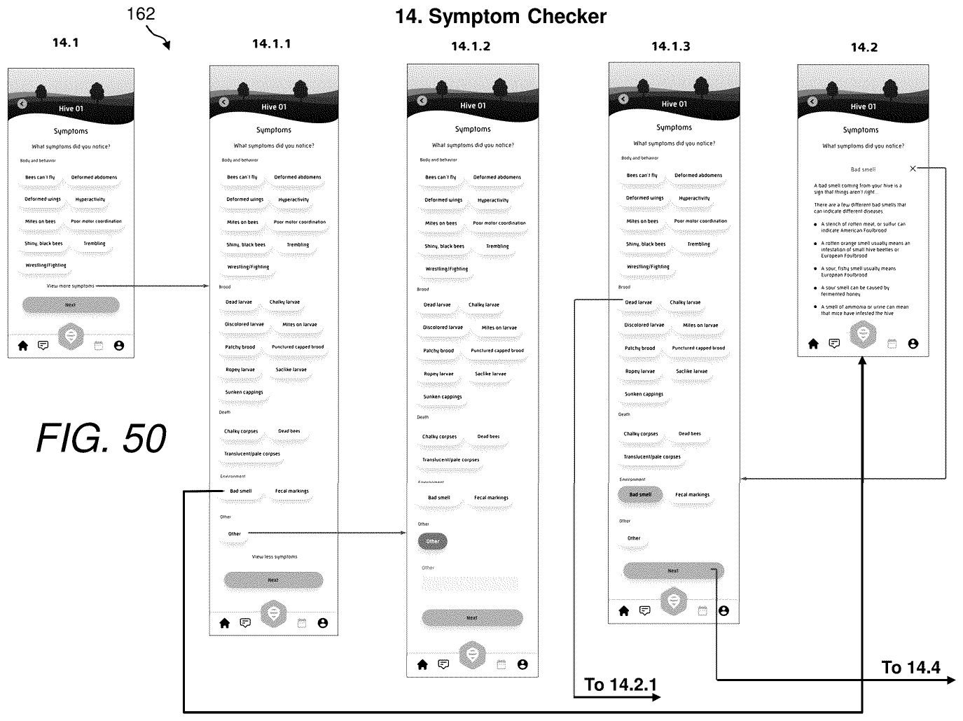

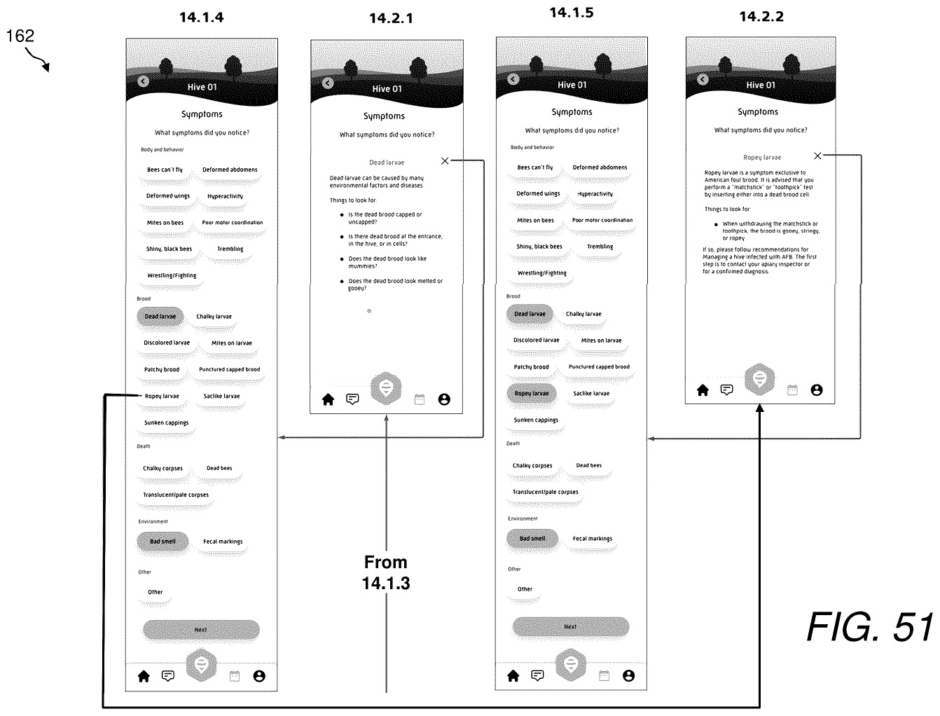

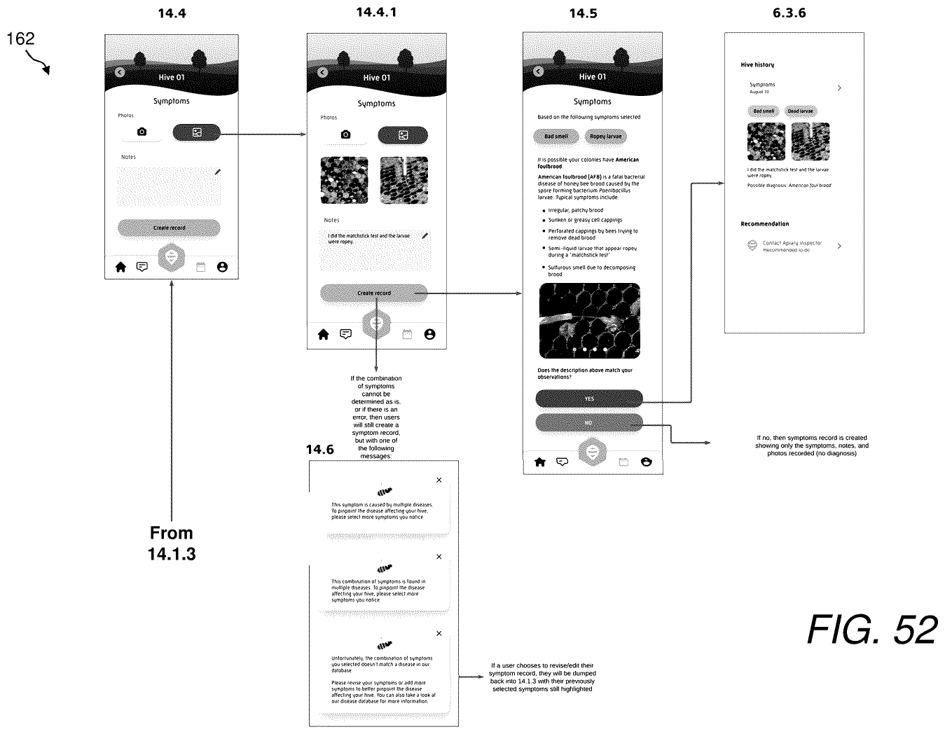

Next, FIG. 50, FIG. 51, and FIG. 52 show examples of “Symptom Checker” screens of hive tracking mobile app 162 and wherein the screens are labeled beginning with the number 14. “Symptom Checker” screens allows the beekeeper 105 to enter information of various observed symptoms and to receive a possible diagnoses and/or recommendation(s) for treatment.

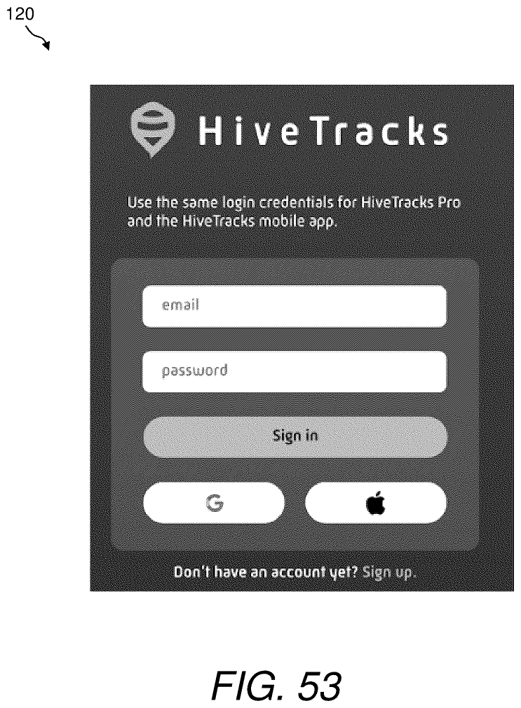

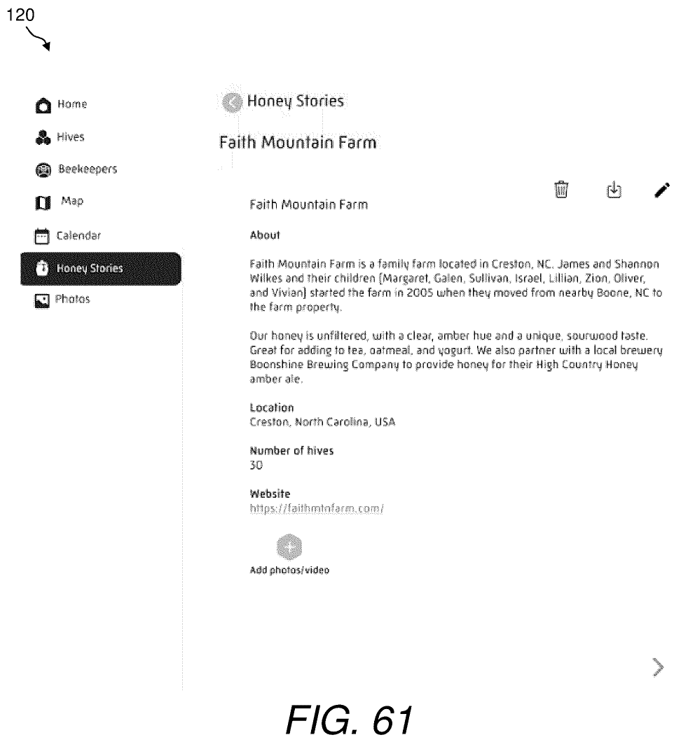

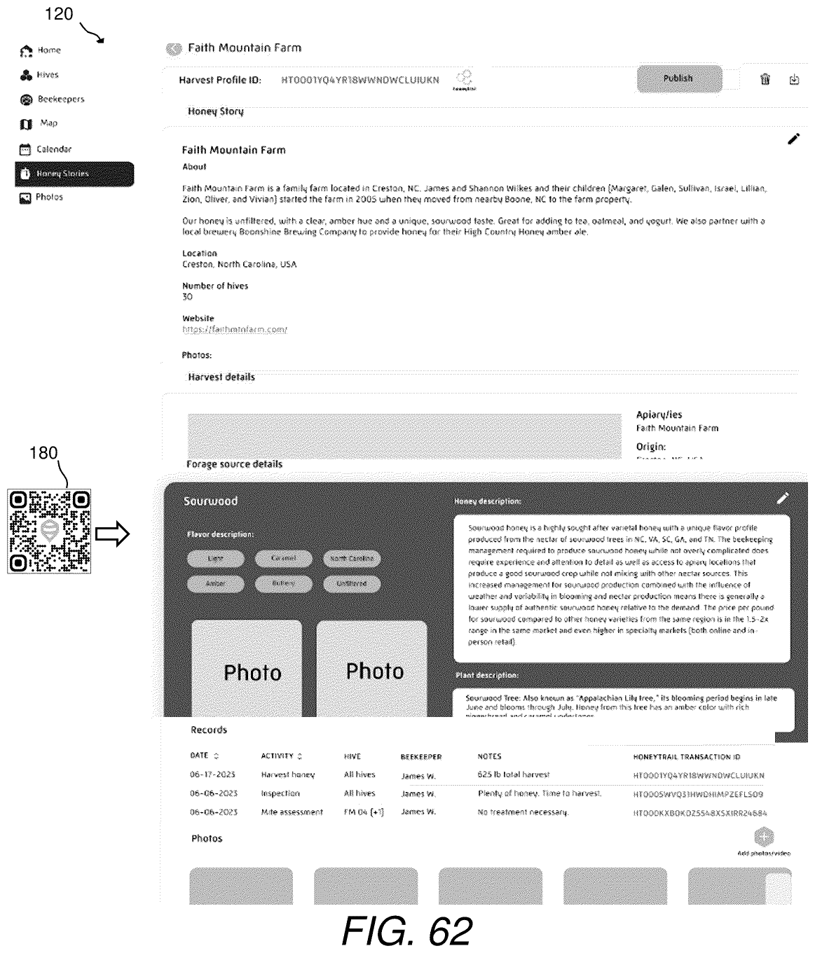

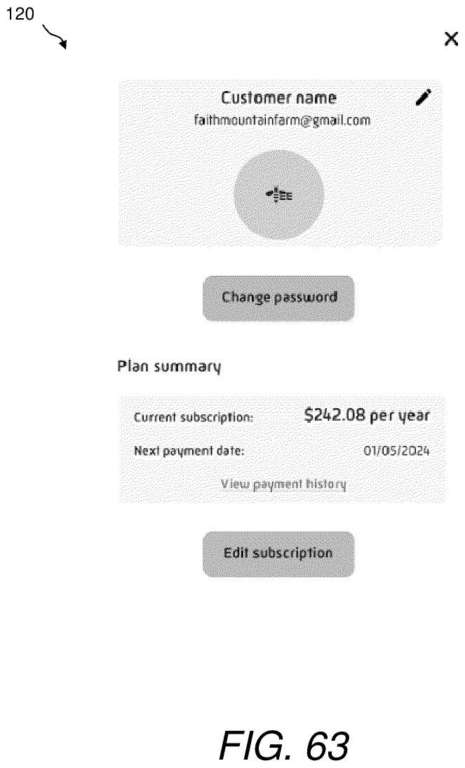

Referring now to FIG. 53 through FIG. 63 are non-limiting example screenshots of an example of web portal 120 of beehive management system 100 shown in FIG. 1, in accordance with an example embodiment of the invention. Web portal 120 may be accessed via any standard web browser.

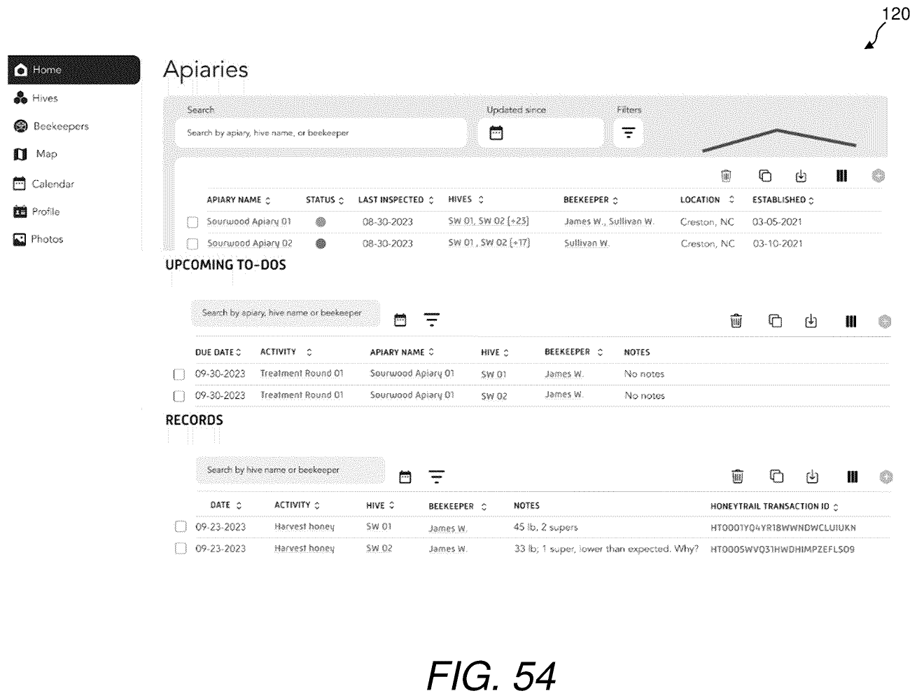

In one example, web portal 120 may show a “Sign In” screen as shown, for example, in FIG. 53, where a user may sign into beehive tracking application 110 of beehive management system 100. In one example, web portal 120 may further include a “Home” tab as shown, for example, in FIG. 54. The “Home” tab screen may show one or more apiaries and their associated details, upcoming to-dos (e.g., treatment), records (e.g., activity, hive, beekeeper, notes, etc.). In one example, the “Home” tab may be the screen the user lands on after signing in through the “Sign In” screen.

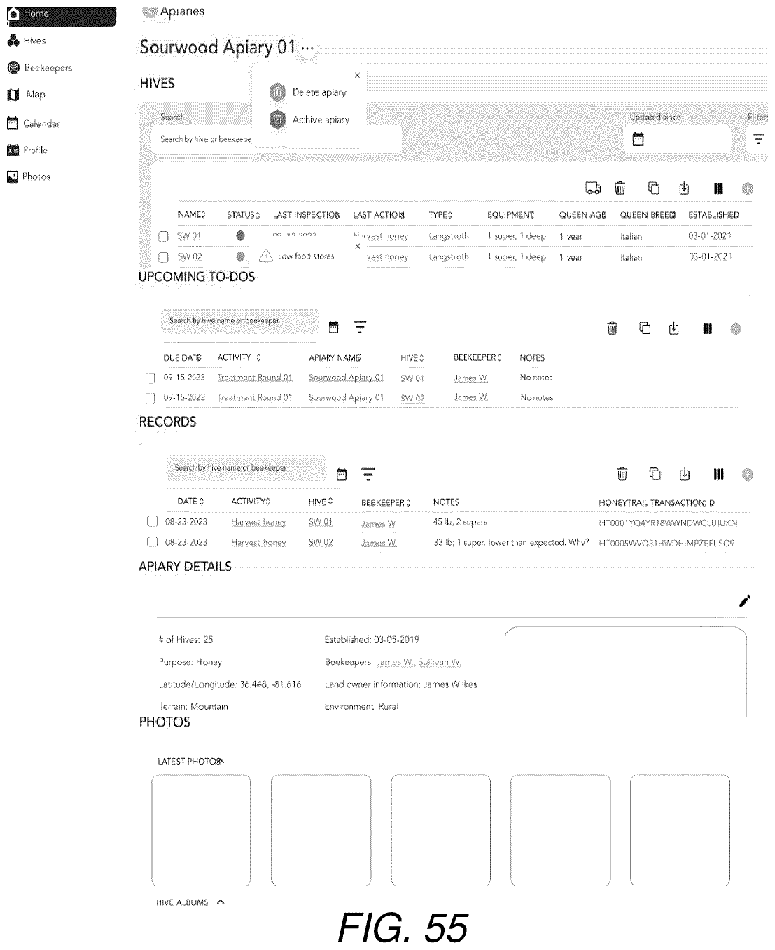

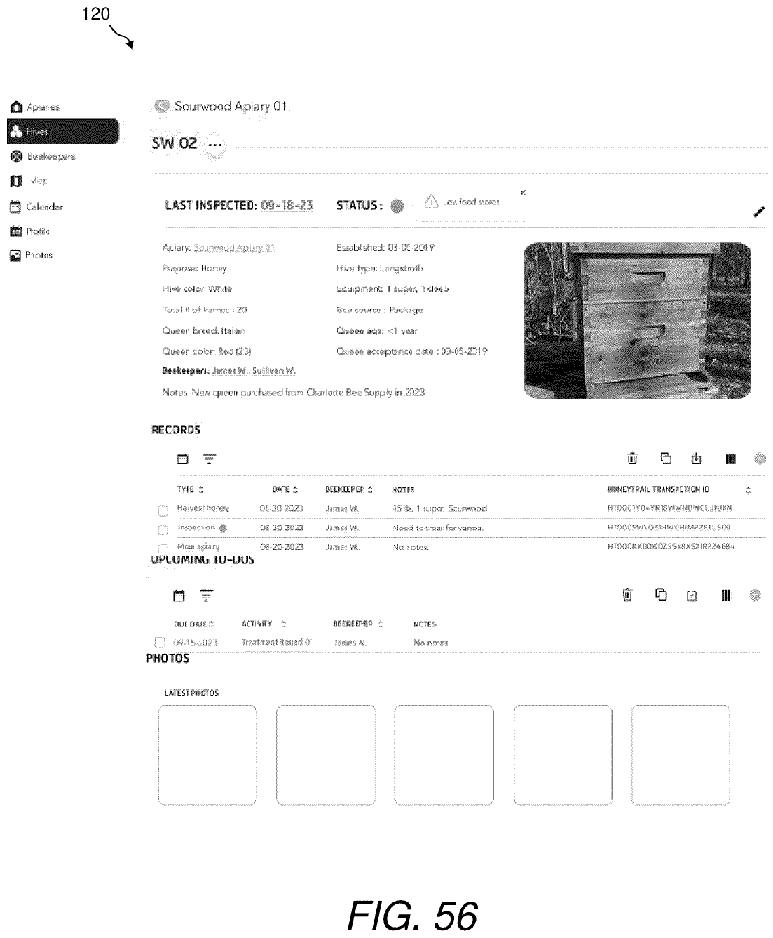

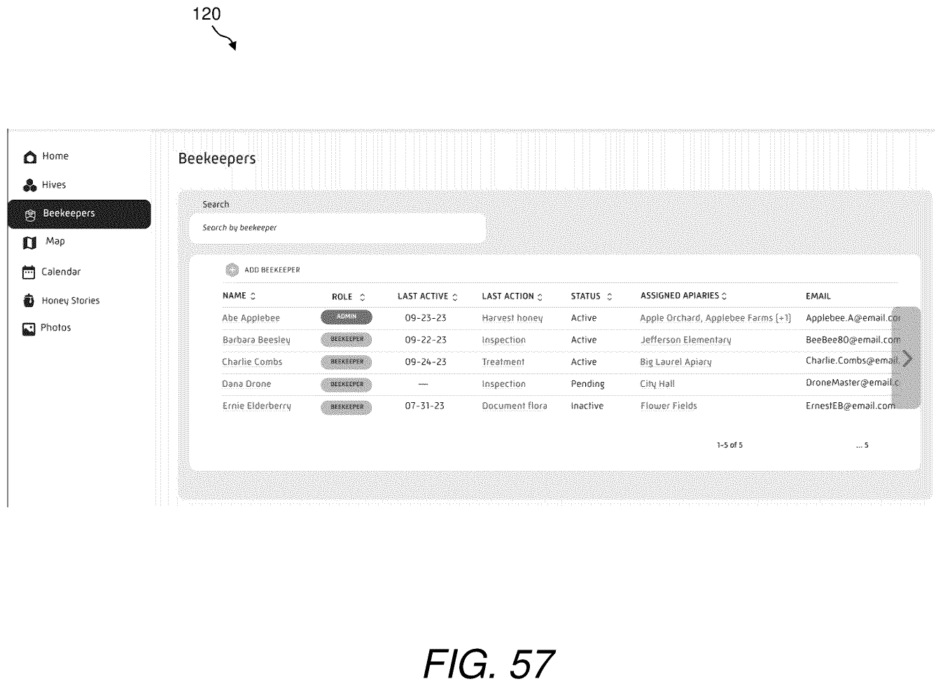

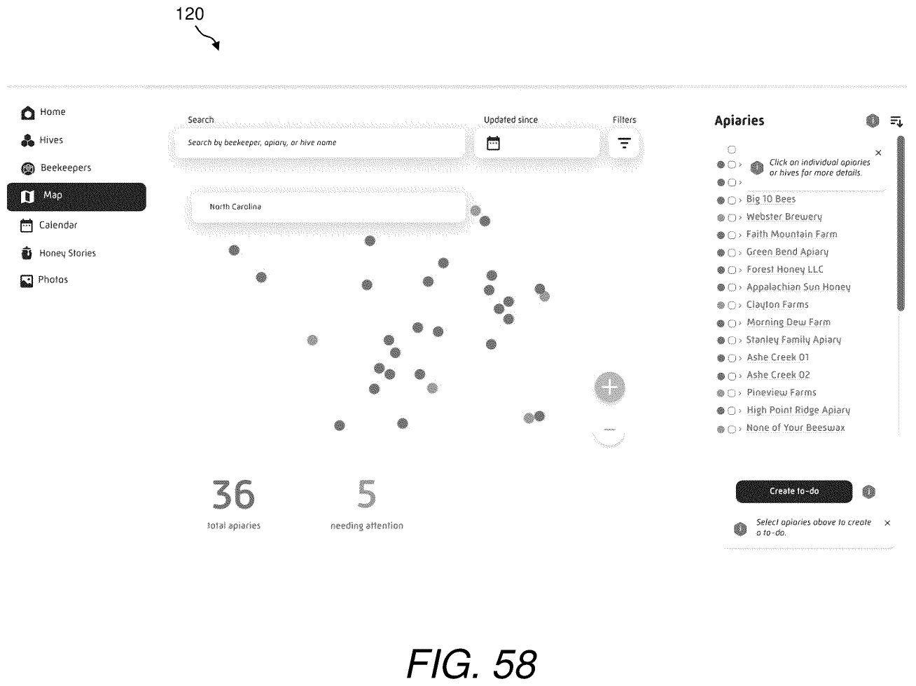

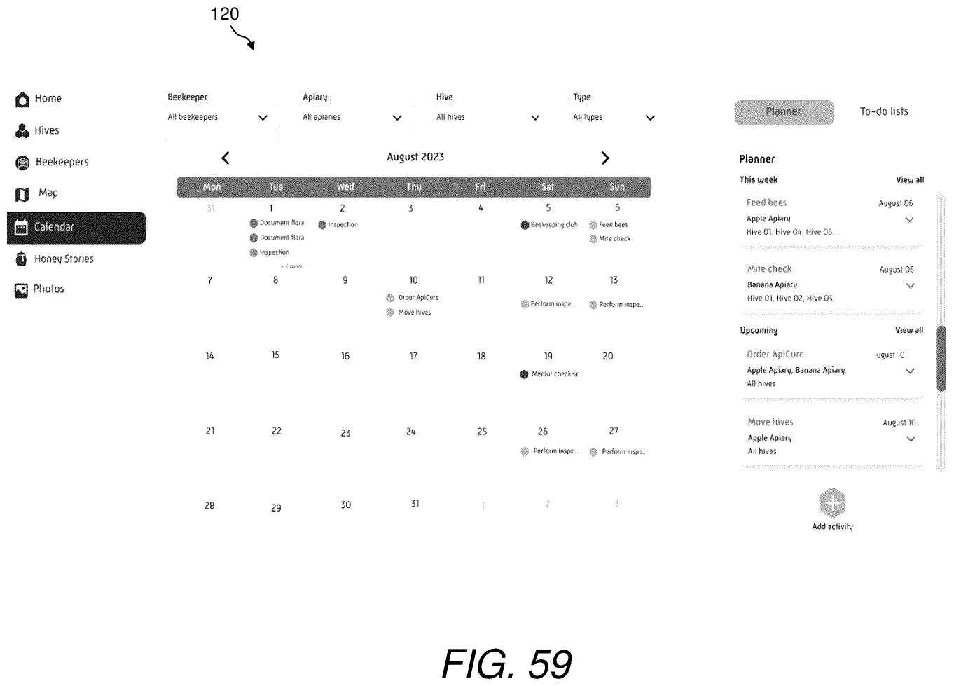

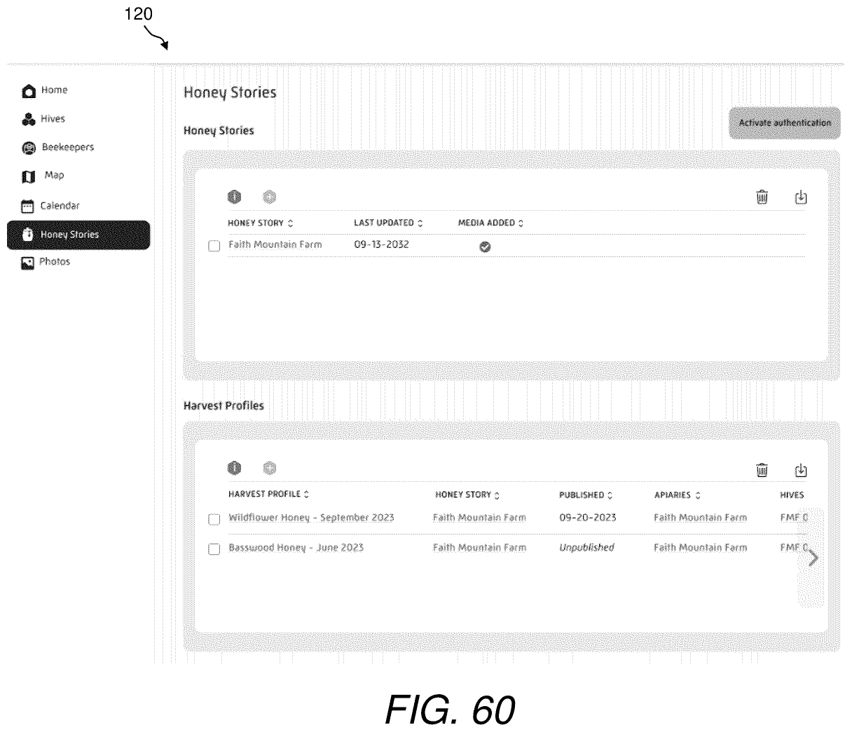

In one example, web portal 120 may show an “Apiary” screen as shown, for example, in FIG. 55. The “Apiary” screen may include details related to one of the apiaries a user selected from the “Home” screen. The “Apiary” screen may also include details related to specific hives of that apiary, upcoming to dos, records related to past activities, photos, and/or the like. In one example, web portal 120 may a “Hive” tab as shown, for example, in FIG. 56. The “Hive” tab screen may include details related to one of the hives a user selected under the “Apiaries” tab. The screen of the “Hive” tab may also include specific details related to the selected hive, last inspection, status, upcoming to dos, records related to past activities, photos, and/or the like. In one example, web portal 120 may show a “Beekeepers” tab as shown, for example, in FIG. 57. The “Beekeepers” tab screen may include the details related to beekeepers associated/registered with one or more of the listed apiaries. The “Beekeepers” screen may also include specific details related to the beekeepers, such as, but not limited to, name, assigned role (beekeeper, admin, etc.), last activity (harvest honey, inspection, treatment, etc.), status (active, in active, pending, etc.), assigned apiaries, contact information, and/or other relevant information. In one example, web portal 120 may include an apiary “Map” tab of a community or region showing locations of apiaries as shown, for example, in FIG. 58. Web portal 120 may also include a “Calendar” tab as shown, for example, in FIG. 59. The “Calendar” tab screen may include the various activities (to dos) that have been scheduled. The “Calendar” tab screen may be filtered by beekeeper, apiary, hive, and or type. Web portal 120 may also include a “Honey Stories” tab as shown, for example, in FIGS. 60-62. The “Honey Stories” tab screens may enable the user to create Honey Stories (e.g., general information about the beekeeper) and harvest profiles (e.g., harvest specific information) that may be tied to a honey story and published, and may be hosted on the server of the beehive management system 100, and may be, for example, accessed directly via a link or through a QR code (e.g., QR code 180) that may be auto-generated based on the user input and may be placed on, for example, a jar of honey or other hive related product(s) (e.g., bees wax, propolis, and/or other honey related products). Web portal 120 may also include an “Billing or Plan” page as shown, for example, in FIG. 63. The “Billing or Plan” page may include, for example, a user's details, specific plan summary, edit capabilities (password, subscription type, etc.), and/or the like. Web portal 120 may include other tabs and/or screens than those listed above.

In summary, and referring now again to FIG. 1 through FIG. 63, the beehive management system 100 and methods provide beehive tracking application 110 and data store 130 running on application server 145 that supports hive tracking mobile app 162 running on, for example, the mobile device of a beekeeper 105.

In some embodiments, the beehive management system and methods provide a software-based, data-driven recommendation engine 112 for beekeepers 105 that uses, for example, hive tracking mobile app 162 to deliver specific advice based on, for example, but not limited to, observational data, blooming data, weather data, and management data.

In some embodiments, the beehive management system 100 and methods provide recommendation engine 112 that uses, for example, hive tracking mobile app 162 to deliver recommended beekeeping management practices based on a plurality of data sources, such as, but not limited to, past practices, regional beekeeper activities, weather data, blooming data, and bee health symptoms observed.

In some embodiments, the beehive management system 100 and methods provide hive tracking mobile app 162 that may include, but is not limited to, a “Welcome” portion, a “Account Create” portion, a “Apiary Creation” portion, a “Home/Apiary” portion, a “Hive Creation” portion, a “Hive/Apiary” portion, a “To-Dos” portion, a “Records” portion, a “Inspection” portion, a “Calendar” portion, a “Profile” portion, a “Community/Message” portion, a “Recommendations” portion, and a “Symptom Checker” portion.

In some embodiments, the beehive management system 100 and methods provide recommendation engine 112 that may be used to improve bee health to increase pollination efficacy and honey harvests by, for example, reducing hive winter losses through improved beekeeper management practices.

In some embodiments, the beehive management system 100 and methods provide a beehive management tool for guiding poorly-experienced beekeepers who otherwise may not be knowledgeable enough on their own to manage beehives effectively.

In some embodiments, the beehive management system 100 and methods provide a beehive management tool for guiding poorly-experienced beekeepers to take certain actions and at the appropriate times to ensure effective management of their beehives and thereby improve the health of the bees and affect improved pollination and honey production.

### Other Uses

Additionally, the use of beehive management system 100 including beehive tracking application 110 that further includes recommendation engine 112 and hive tracking mobile app 162 is not limited to beehive management only. Beehive management system 100 may have other uses, for example in financial services.

In one example, using recommendation engine 112, beehive management system 100 may be used to provide proof of authentication; that is, authenticating the production and origin of the honey. For example, a beekeeper's pattern of interactions with hive informs recommendation engine 112 as to where, how, and when honey was produced. This allows beehive management system 100 to give the buyer an idea of how authentic the honey is, and for example may be accessed via a QR code or the like that may be generated on the beekeeping platform. This may be derived from interactions with recommendation engine 112.

In another example, using recommendation engine 112, beehive management system 100 may be used to provide a way to financially renumerate beekeepers for the ecosystem services that they deliver. Similar to the carbon offsetting market. For example, payments that are brokered through the beekeeping platform of beehive management system 100 may be made to beekeepers around the world based on the ecosystem services they provide to a region, or on the biodiversity monitoring services they deliver as part of Monitoring, Reporting and Verification of Biodiversity and Carbon Credits.

In yet another example, using beehive management system 100, the data or interactions with the recommendation engine 112 may be used as collateral for financial services. For example, for beekeepers to receive a loan from financial institutions based on their interaction with recommendation engine 112 and/or hive tracking mobile app 162, the operations or business data on the apiaries and types of hives and/or production volumes/amounts of honey they have in hive tracking mobile app 162.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter. For example, the term “about,” when referring to a value can be meant to encompass variations of, in some embodiments±100%, in some embodiments±50%, in some embodiments±20%, in some embodiments ±10%, in some embodiments±5%, in some embodiments±1%, in some embodiments ±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A beehive management system, comprising:
a. a server, the server comprising a server beehive tracking application, a controller, operating memory, and a communications interface;
b. a data store connected to the server; and
c. wherein the controller is configured to execute stored program instructions, comprising:
i. receiving data related to a beehive, through a network, from one or more sources;
ii. processing the beehive data;
iii. assessing a state of the beehive based on the processed beehive data; and
iv. generating one or more recommendations by a recommendations engine of the beehive management system to improve the state of the beehive.

2. The system of claim 1, further comprising a user access device, connectable to the server through the network, the user access device including a display, a user input configured to receive input from a user, and a communications interface.

3. The system of claim 2, further comprising a user interface device beehive tracking application.

4. The system of claim 1, wherein the beehive is part of an apiary.

5. The system of claim 1, wherein the related beehive data comprises data related to any one or more of environment, terrain, region, atmospheric, weather, meteorological, plant availability, native pollinators, hive inspection, observation, number of hives, hive/queen details, flora/bloom, insect occurrences, beekeeper experience level, honey production, past and/or current beehive management practices, results of actions based on one or more of the generated recommendations, and/or historical data of any one or more of the foregoing.

6. The system of claim 1, wherein the one or more sources comprise any one or more of National Weather Service (NWS), National Oceanic and Atmospheric Administration (NOAA), National Aeronautics and Space Administration (NASA), the data store, direct input, data accessible through the network, other beekeepers, internal and/or external sensors, and/or any third-party entities that process or provide information from or based on any of the foregoing.

7. The system of claim 1, wherein the recommendations engine comprises a machine learning component in generating the one or more recommendations.

8. The system of claim 2, wherein the controller is configured to execute stored program instructions further comprising sending one or more push notifications to the user access device of the user.

9. The system of claim 8, wherein the one or more push notifications comprise the generated one or more recommendations.

10. The system of claim 2, wherein the beehive data is processed and assessed in real time.

11. The system of claim 2, wherein the recommendations engine relies on real time beehive data input and/or stored beehive data input in generating the one or more recommendations.

12. The system of claim 2, wherein the beehive data is used for any one or more of authenticating honey origin, local impact of pollination ecosystem, biodiversity monitoring, and/or access to financial services.

13. A method of using a beehive management system, the method comprising:
a. receiving data related to a beehive, through a network, from one or more sources;
b. processing the beehive data;
c. assessing a state of the beehive based on the processed beehive data; and
d. generating one or more recommendations by a recommendations engine of the beehive management system to improve the state of beehive.

14. The method of claim 13, wherein assessing the state of the beehive comprises providing a health assessment of the beehive.

15. The method of claim 13, wherein the beehive is part of an apiary.

16. The method of claim 13, further comprising accessing the beehive management system via a user access device, through the network, the user access device including a display, a user input configured to receive input from a user, and a communications interface.

17. The method of claim 16, wherein the user access device further comprises a user interface device beehive tracking application.

18. The method of claim 13, wherein the related beehive data comprises data related to any one or more of environment, terrain, region, atmospheric, weather, meteorological, hive inspection, observation, number of hives, hive/queen details, flora/bloom, insect occurrences, beekeeper experience level, honey production, past and/or current beehive management practices, results of actions based on one or more of the generated recommendations, and/or historical data of any one or more of the foregoing.

19. The method of claim 13, wherein the one or more sources comprise any one or more of National Weather Service (NWS), National Oceanic and Atmospheric Administration (NOAA), National Aeronautics and Space Administration (NASA), the data store, direct input, data accessible through the network, other beekeepers, internal and/or external sensors, and/or any third-party entities that process or provide information from or based on any of the foregoing.

20. The method of claim 13, wherein the recommendations engine comprises a machine learning component in generating the one or more recommendations.

21. The method of claim 13, further comprising sending one or more push notifications to the user access device of the user.

22. The method of claim 21, wherein the one or more push notifications comprise the one or more generated recommendations.

23. The method of claim 13, wherein the beehive data is processed and assessed in real time.

24. The method of claim 13, wherein the recommendations engine relies on real time beehive data input and/or stored beehive data input in generating the one or more recommendations.

25. The method of claim 13, wherein the beehive data is used for any one or more of authenticating honey origin, local impact of pollination ecosystem, biodiversity monitoring, and/or access to financial services.

26. A non-transitory computer readable storage medium storing a program of instructions executable by a machine to perform a method of using a beehive management system, the method comprising:
a. receiving data related to a beehive, through a network, from one or more sources;
b. processing the beehive data;
c. assessing a state of the beehive based on the processed beehive data; and
d. generating one or more recommendations by a recommendations engine of the beehive management system to improve the state of beehive.
